(19) United States
(12) Patent Application Publication
(10) Pub. No.: US 2017/0080346 A1
(43) Pub. Date: Mar. 23, 2017

(54) METHODS AND SYSTEMS RELATING TO PERSONALIZED EVOLVING AVATARS

(71) Applicant: MOHAMAD ABBAS, OTTAWA (CA)

(72) Inventor: MOHAMAD ABBAS, OTTAWA (CA)

(21) Appl. No.: 15/308,254

(22) PCT Filed: May 1, 2015
(86) PCT No.: PCT/CA2015/000284

§ 371 Date: Nov. 1, 2016

Related U.S. Application Data
(60) Provisional application No. 61/986,957, filed on May 1, 2014.
(60) Provisional application No. 61/986,919, filed on May 1, 2014.

(51) Int. Cl. A63F 13/825; H04L 12/58; A63F 13/79

(52) U.S. Cl. CPC A63F 13/825; A63F 13/79; H04L 51/32; A63F 2300/5553

(57) ABSTRACT

Graphical user interfaces can exploit avatars to provide represent the user or their alter ego or character. It would be beneficial to provide users with an avatar not defined by the software provide but one that represents their quantified self so that their virtual world avatar evolved, adjusted, and behaved based upon the real world individual. It would also be beneficial that such a dynamically adaptive avatar provides the individual with an evolving and adjusting graphical interface to access personal information, establish adjustments in lifestyle, and monitor their health etc. within the real world but also define the characteristics, behaviour, skills, etc. that they possess within virtual worlds. Accordingly, such an avatar established in dependence upon the user's specific characteristics can then be exploited to provide data for a wide range of additional aspects of the user's life from filtering content through to controlling devices within their environment.

### CROSS-REFERENCE TO RELATED APPLICATIONS

This patent application claims the benefit of International Patent Application PCT/CA2015/000284 filed May 1, 2015 entitled “Methods and Systems Relating to Personalized Evolving Avatars” which itself claims the benefit of U.S. Provisional Patent Application US 61/986,957 filed May 1, 2014 entitled “Methods and Systems relating to Personalized Evolving Avatars” and U.S. Provisional Patent Application US 61/986,919 filed May 1, 2014 entitled “Methods and Systems relating to Biometric Automation”, the entire contents of which are included by reference.

### FIELD OF THE INVENTION

This invention relates to avatars and more particularly to personalized avatars that evolve and adapt to reflect the user's growth and development as well as provide external representations of the user to third parties.

### BACKGROUND OF THE INVENTION

Over the past decade the increasing power of microprocessors coupled with low cost electronic solutions, supporting cellular wireless services as well as personal and local area networks (PANs/LANs), low cost colour displays, social networks, and a range of different software applications have meant that access to information, content, and services has become ubiquitous. Users access software programs and software applications through a variety of graphical user interfaces (GUIs) allowing the users to interact through graphical icons and visual indicators such as secondary notation, as opposed to text-based interfaces, typed command labels or text navigation. Within many programs, applications, and GUIs an avatar (usually translated from Sanskrit as incarnation) represents or provides a graphical representation of the user or the users alter ego or character. It may take either a three-dimensional form, usually within games or virtual worlds, or a two-dimensional form as an icon in Internet forums and other online communities. The term “avatar” can also refer to the personality connected with the screen name, or handle, of an Internet user.

Within the prior art an avatar as used within most Internet forums is a small (80×80 to 100×100 pixels, for example) square-shaped area close to the user's forum post, where the avatar is placed in order for other users to easily identify who has written the post without having to read their username. Some forums allow the user to upload an avatar image that may have been designed by the user or acquired from elsewhere. Other forums allow the user to select an avatar from a preset list or use an auto-discovery algorithm to extract one from the user's homepage. Some avatars are animated, consisting of a sequence of multiple images played repeatedly. Other avatar systems exist where a pixelized representation of a person or creature is used, which can then be customized to the user's wishes. There are also avatar systems where a representation is created using a person's face with customized characters and backgrounds. Instant messaging avatars are usually very small, in fact some have been as small as 16×16 pixels but are used more commonly at the 48×48 pixels size, although many icons can be found online that typically measure anywhere from 50×50 pixels to 100×100 pixels in size.

Today, the most varied and sophisticated avatars are within the realms of massively multiplayer online games (MMOGs) where players in some instances may construct a wholly customized representation from a range of available templates and then customize through preset hairstyles, skin tones, clothing, etc. Similarly, avatars in non-gaming online worlds are typically two- or three-dimensional human or fantastic representations of a person's in-world self and facilitate the exploration of the virtual universe, or act as a focal point in conversations with other users, and can be customized by the user. Usually, the purpose and appeal of such universes is to provide a large enhancement to common online conversation capabilities, and to allow the user to peacefully develop a portion of a non-gaming universe without being forced to strive towards a pre-defined goal.

In Second Life™ avatars are created by residents (i.e. the users) and take any form, and range from lifelike humans to robots, animals, plants and mythical creatures. Avatar customization is one of the most important entertainment aspects in gaming and non-gaming virtual worlds and many such virtual worlds provide tools to customize their representations, allowing them to change shapes, hair, skins, gender, and also genre. Moreover there is a growing secondary industry devoted to the creations of products and items for the avatars. Some companies have also launched social networks and other websites for linking avatars from different virtual worlds such as Koinup, Myrl, and Avatars United.

As such avatars have grown in use, then services to centralize the design, management, and transportation of digital avatars have begun to appear such that they are deployed in virtual worlds, online games, social networks, video clips, greeting cards, and mobile apps, as well as professional animation and pre-visualization projects. One such service is Autodesk® Character Generator, formerly Evolver from Darwin Dimensions, which provides a user with control over a character's body, face, clothes and hair, and can use colors, textures and artistic styles. Once complete the character can be stored in a standard file format and then animated through popular animation packages, e.g. Autodesk® Maya and Autodesk® 3ds Max®, as well as in game engines like Unity. The generated characters can be used in hobbyist, student, and commercial projects such as games, architectural visualizations as well as film and TV projects.

However, in all of these instances of avatars the user has the ability to control the design of their personal avatar or avatars within the confines of the avatar generator within each online gaming or non-gaming application. Accordingly, many buxom, young, long blonde haired, female characters and their avatars are in reality associated with accounts that are actually owned by males. Further, a user may in fact have multiple avatars generated within one or more virtual environments and pretend to be multiple personas to another user. Once created these avatars are basically constant apart from the animations provided within the application and/or virtual environment such as simulating walking, running, etc.

Accordingly, it would be beneficial to provide users with an avatar that represents their quantified self, i.e. the characteristics and behaviour of a virtual world avatar associated with an individual evolved, adjusted, and behaved based upon the corresponding aspects of the real world individual. It would also be beneficial that such a dynamically adaptive avatar which evolves, adjusts, and behaves with individual defined aspects also provides the individual with an evolving and adjusting graphical interface for the user to access personal information, establish adjustments in lifestyle, and monitor their health etc. within the real world but also define the characteristics, behaviour, skills, etc. that they possess within virtual worlds.

Irrespective of an individual's online persona the convergence of computerization, wireless capabilities, digitalization, and ease of dissemination, means that the amount of potential information that may be bombarded on individual users may prove overwhelming whether solicited or unsolicited. In many instances this sheer volume of information may prevent or discourage users from making any effort to examine the information and find what is immediately desirable or necessary. In general, current solutions for selecting solicited or unsolicited content fail because they do not address on the one hand the dynamic, immediate, and arbitrary desires and needs of a user and on the other the specific requirements of that user. Accordingly, with an avatar established in dependence upon the user's specific characteristics then beneficially the avatar's reflection of the user and its automatic “evolution” with the user means that it can be exploited to provide data for a wide range of additional aspects of the user's life from filtering content through to controlling devices within their environment.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to electronic content and more particularly to targeting or selecting content by determining and using biometric information of a user or group of users. The present invention may do so by determining and using biometric information relating to the user.

In accordance with an embodiment of the invention there is provided a method comprising aggregating biometric data relating to a user with user data relating to the user, and generating in dependence upon the aggregated data an avatar for presentation upon an electronic device.

In accordance with an embodiment of the invention there is provided a method comprising acquiring over a period of time biometric data relating to a user, acquiring over the period of time physical appearance data relating to the user, and providing to the user a graphical interface comprising an avatar generated in dependence upon the biometric data and physical appearance data of the user at a predetermined point in time.

In accordance with an embodiment of the invention there is provided a method comprising aggregating biometric data relating to a user, allowing the user to select a predetermined subset of the aggregated biometric data to be displayed as part of a profile within a social network associated with the user, and allowing the user to determined what portion of their displayed profile within the social network to other users is based upon the predetermined subset of the aggregated biometric data.

In accordance with an embodiment of the invention there is provided a method comprising aggregating biometric data relating to a user, and allowing another user to at least one of view and follow the user on a social network, wherein the user is established in dependence upon at least one of a search and filtering process performed in dependence upon the aggregated biometric data relating to the user meeting a predetermined criteria.

In accordance with an embodiment of the invention there is provided a method comprising aggregating biometric data relating to a user with user data relating to the user to form aggregated biometric data, and displaying the aggregated biometric data to the user by presenting them with an avatar whose characteristics are derived in dependence upon the aggregated biometric data and a context of the user.

In accordance with an embodiment of the invention there is provided a method comprising displaying an avatar within a graphical interface to a user associated with the avatar, wherein the avatar dynamically adjusts to reflect changes in at least one of information relating to the location of the user, information relating to the environment of the user, current biometric data relating to the user, and personal information relating to the user.

In accordance with an embodiment of the invention there is provided a method comprising providing information to a user via an avatar associated with the user, wherein the avatar acquires at least one of skills, intelligence, biometric data, emotions, health information, real time content, and content within one or more virtual environments, and the avatar communicates to the user via a brain machine interface.

In accordance with an embodiment of the invention there is provided a method of presenting a profile of a user within a social network to another user comprising retrieving data relating to an avatar associated with the user, retrieving data relating to the current context of the user, retrieving data relating an appearance of the avatar, the appearance of the avatar determined in dependence upon the social network and the current context of the user, generating a representation of the avatar based upon the data relating to the appearance as part of a social network profile associated with the user, and displaying the social network profile to another user.

In accordance with an embodiment of the invention there is provided a method of presenting a profile of a user within a social network to another user comprising retrieving biometric data relating to the user, filtering the retrieved biometric data in determination upon at least one of the social network, the current context of the user, and the identity of the another user, generating a representation of the filtered retrieved biometric data as part of a social network profile associated with the user, and displaying the social network profile to another user.

In accordance with an embodiment of the invention there is provided a method comprising associating a biometric fence with respect to a user, receiving biometric data relating to the user, and processing the biometric data in dependence upon a predetermined threshold of a plurality of thresholds to determine whether to apply to the biometric fence to the user.

In accordance with an embodiment of the invention there is provided a method comprising detecting an illegal activity by receiving data relating to an event involving an individual, receiving biometric data relating to the individual, and determining in dependence upon the received data and received biometric data whether the user's biometric data is outside of a predetermined range.

In accordance with an embodiment of the invention there is provided a method comprising automatically generating a profile of a user upon an electronic device by observing activities that the user partakes in, observing locations that the user visits, and associating biometric data of the user with each activity and location, and determining an activity of a user based upon the profile of the user and the user's current biometric data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3A depicts an avatar associated with a young woman in first and second contexts according to an embodiment of the invention as may be presented within virtual and online environments;

FIG. 3B depicts wearable technology supporting biometric data acquisition and/or presentation to systems according to embodiments of the invention;Figure 4A depicts the dynamic adjustment of an avatar within a social network according to the social network page owner's context;

FIG. 4B depicts an avatar associated with a woman in varying contexts according to an embodiment of the invention as may be presented with virtual and online environments;

FIG. 4C depicts an generator for a user adapting a baseline avatar to provide context avatars according to an embodiment of the invention;

FIG. 5 depicts an avatar associated with a woman in evolving contexts according to an embodiment of the invention as may be presented with virtual and online environments;

FIGS. 6 and 7 depict an avatar timeline associated with a woman according to an embodiment of the invention at different time points;

FIGS. 8 depicts an avatar timeline associated with a woman according to an embodiment of the invention at different time points;

FIG. 9 depicts an avatar nutritional interface associated with a woman according to an embodiment of the invention at different time points and predictive avatar based outcomes of decisions;

FIG. 10 depicts an avatar nutritional interface associated with a woman according to an embodiment of the invention at different time points and predictive avatar based outcomes of decisions;

FIG. 11 depicts an avatar based medical interface according to an embodiment of the invention depicting respiratory and heart aspects of the user of the avatar based medical interface;

FIG. 12 depicts adaptation of an avatar based interface to online gaming environments according to an embodiment of the invention;

FIG. 13 depicts establishing a gaming group based upon avatars associated with users according to an embodiment of the invention;

FIG. 14 depicts application of an avatar according to an embodiment of the invention within an online community environment;

FIG. 15 depicts application of an avatar based interface according to an embodiment of the invention with non-human associations;

FIG. 16 depicts an avatar interface for a user with respect to a summary screen and snapshot summary entry screens for the user according to an embodiment of the invention;

FIG. 17 depicts avatar interfaces for a user associating keywords to their snapshot summary assessments according to an embodiment of the invention;

FIG. 18 depicts avatar interfaces for a user relating to trend views for different aspects of the user according to an embodiment of the invention;

FIG. 19 depicts avatar interfaces for a user relating to insight views for different aspects of the user according to an embodiment of the invention;

FIG. 20 depicts avatar interfaces for a user relating to goal management screens according to an embodiment of the invention;

FIG. 21 depicts avatar interfaces for a user according to an embodiment of the invention;

FIG. 22 depicts avatar interfaces for a user managing gear relating to their avatar according to an embodiment of the invention;

FIG. 23 depicts avatar interfaces for a user relating to challenges according to an embodiment of the invention;

FIG. 24 depicts avatar interfaces for a user relating to their home screen portrayed to other users and friend search screen according to an embodiment of the invention;

FIG. 25 depicts avatar interfaces for a user relating to managing their intelligence according to an embodiment of the invention;

FIG. 26 depicts an exemplary implementation of an embodiment of the invention embodied as a wearable computer;

FIG. 27 depicts the adaptation of an avatar based interface to online gaming environments according to an embodiment of the invention;

FIG. 28 depicts gaming character selection and association with a user's avatar based upon biometric data according to an embodiment of the invention;

FIGS. 29 and 30 depict a social network and associated mini-feed engine relating to establishing a biometric feed about a subject user via the social network according to an embodiment of the invention;

FIG. 31 depicts a flow diagram of an exemplary process for generating and displaying a biometric feed about activities of a user of a SOCNET; and

FIG. 32 depicts an activity diagram for profiling a user.

### DETAILED DESCRIPTION

The present invention is directed to advertising and more particularly to targeting advertising by determining and using biometric information of a user or group of users.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by data relating to a subset of conditions including, but not limited to, their environment, medical condition, condition, biological condition, physiological condition, chemical condition, ambient environment condition, position condition, neurological condition, drug condition, and one or more specific aspects of one or more of these said conditions.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Quantified self” as used herein may refer to, but is not limited to, the acquisition and storage of data relating to a user's daily life in terms of inputs (e.g. food consumed, quality of surrounding air), states (e.g. mood, arousal, blood oxygen levels), and performance (mental and physical). Acquisition of data may be combine wearable sensors (EEG, ECG, video, etc.) and wearable computing together with audio, visual, audiovisual and text based content generated by the user.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, heart rate, temperate, altitude, vibration, motion, perspiration, EEG, ECG, energy level, etc. In addition biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

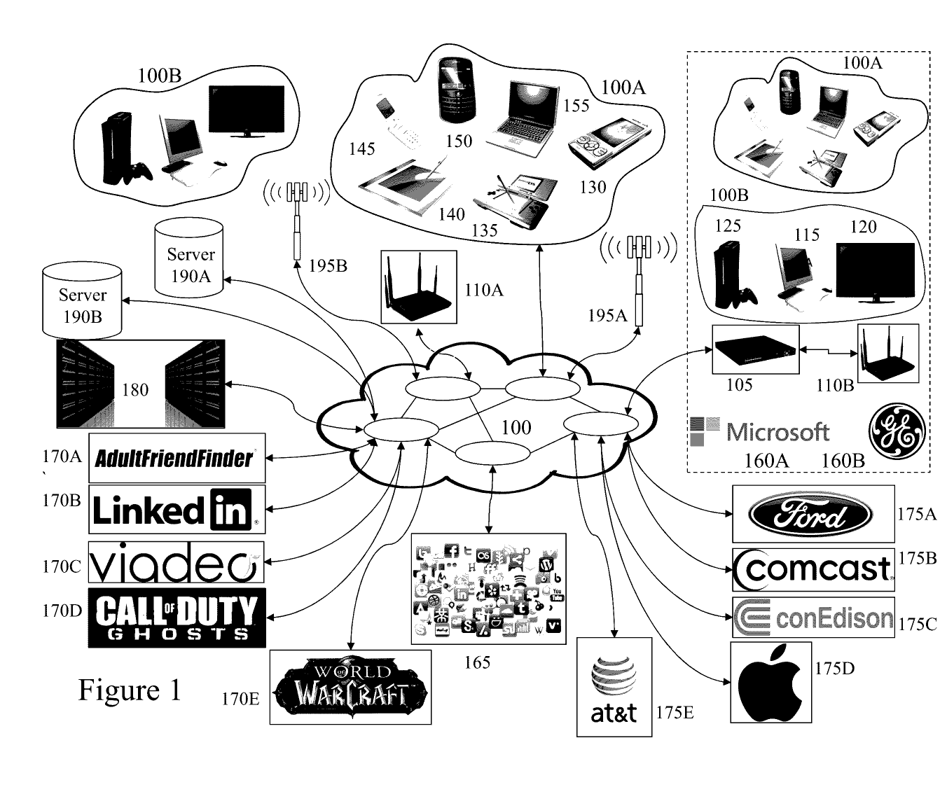

Referring to FIG. 1 there is depicted a network environment 100 within which embodiments of the invention may be employed supporting biometrically based systems, applications, and platforms (BIOSAPs) according to embodiments of the invention. Such BIOSAPs, for example supporting multiple channels and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, such as General Electric™ or Microsoft™ for example, within which other first and second user groups 100A and 100B are disposed. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, personal service provider, e.g. AdultFriendFinder™, first and second business networks 170B and 170C respectively, e.g. LinkedIn™ and Viadeo™, first to second online gaming communities 170D and 170E respectively, e.g. Call of Duty™ Ghosts and World of Warcraft™, as well as first and second servers 190A and 190B which together with others, not shown for clarity. Also connected are original equipment manufacturer (OEM) 175A, e.g. Ford™, residential service provider 175B, e.g. Comcast™, a utility service provider 175C, e.g. ConEdison™, an electronics OEM 175D, e.g. Apple™, and telecom service provider 175E, e.g. AT&T. Accordingly, a user employing one or more BIOSAPs may through their avatar and/or avatar characteristics interact with one or more such providers, enterprises, and third parties.

First and second servers 190A and 190B may host according to embodiments of the inventions multiple services associated with a provider of publishing systems and publishing applications/platforms (BIOSAPs); a provider of a SOCNET or Social Media (SOME) exploiting BIOSAP features; a provider of a SOCNET and/or SOME not exploiting BIOSAP features; a provider of services to PEDS and/or FEDS; a provider of one or more aspects of wired and/or wireless communications; an Enterprise 160 exploiting BIOSAP features; license databases; content databases; image databases; content libraries; customer databases; websites; and software applications for download to or access by FEDs and/or PEDs exploiting and/or hosting BIOSAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides BIOSAP features according to embodiments of the invention; execute an application already installed providing BIOSAP features; execute a web based application providing BIOSAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

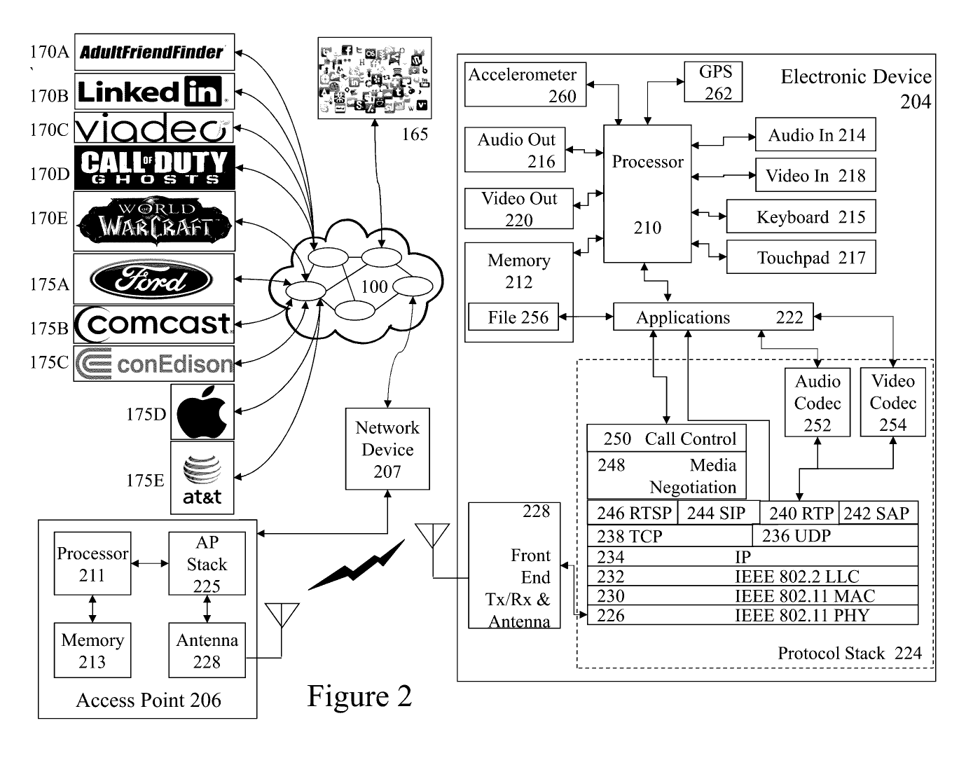

Now referring to FIG. 2 there is depicted an electronic device 204 and network access point 207 supporting BIOSAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, Also connected to the network 100 are Social Networks (SOCNETS) 165, personal service provider, e.g. AdultFriendFinder™, first and second business networks 170B and 170C respectively, e.g. LinkedIn™ and Viadeo™, first to second online gaming communities 170D and 170E respectively, e.g. Call of Duty™ Ghosts and World of Warcraft™, as well as first and second servers 190A and 190B which together with others, not shown for clarity. Also connected are original equipment manufacturer (OEM) 175A, e.g. Ford™, residential service provider 175B, e.g. Comcast™, a utility service provider 175C, e.g. ConEdison™, an electronics OEM 175D, e.g. Apple™, and telecom service provider 175E, e.g. AT&T. Accordingly, a user employing one or more BIOSAPs may through their avatar and/or avatar characteristics interact with one or more such providers, enterprises, and third parties.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

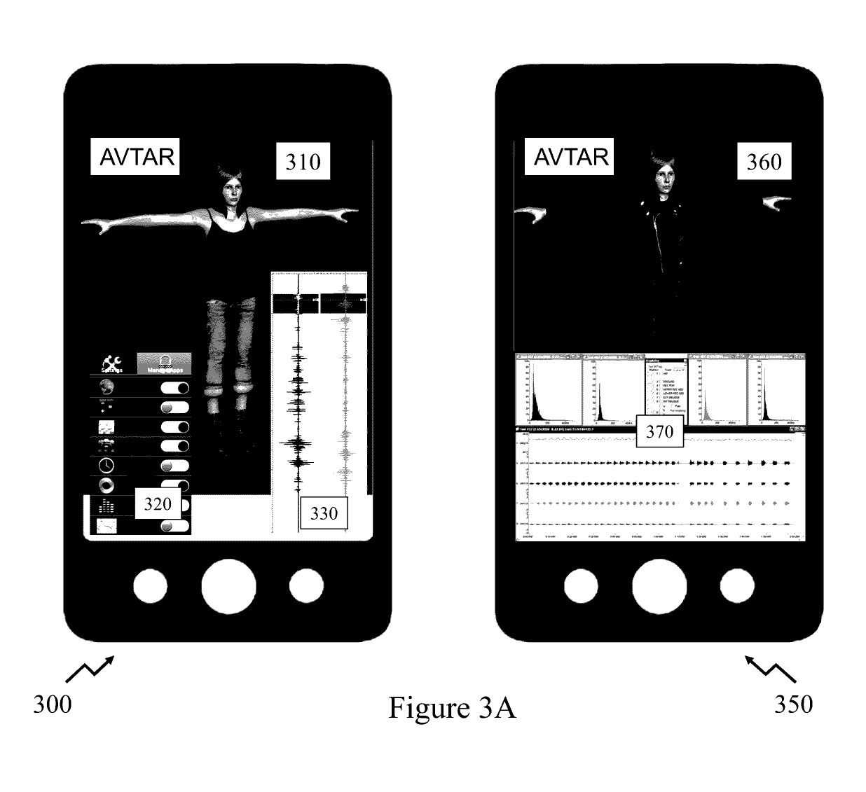

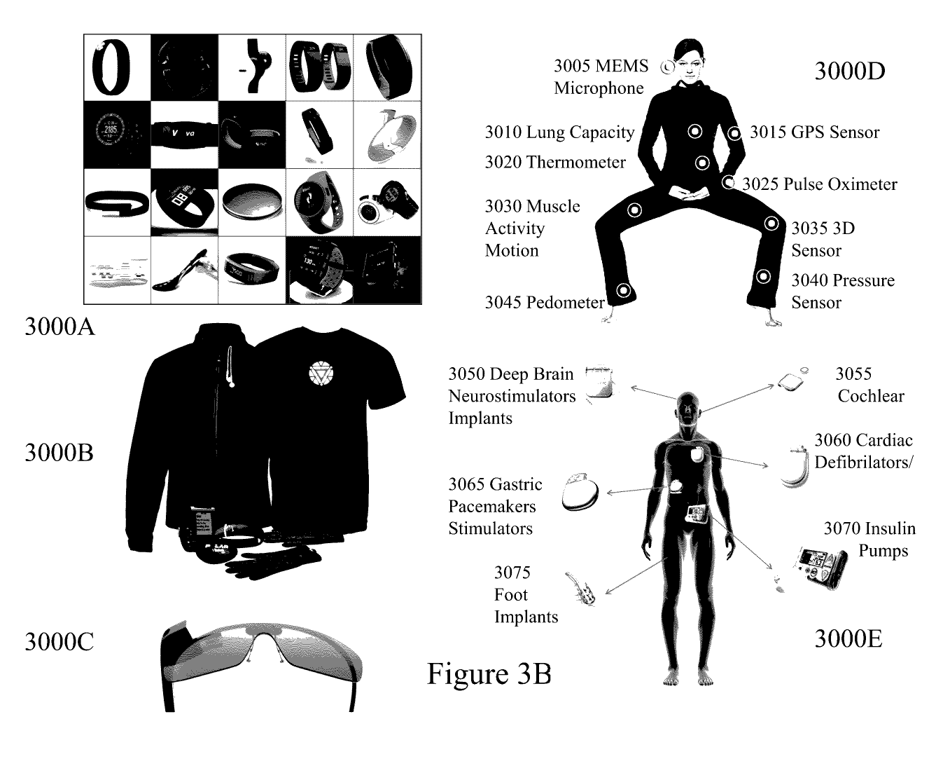

Referring to FIG. 3A there are depicted first and second screens 300 and 350 respectively depicting an avatar associated with a young woman in first and second contexts according to an embodiment of the invention as may be presented within virtual and online environments. Considering first screen 300 the user's avatar is depicted in a first context, by first avatar 310, which as the user is a 17 year old female student and it is a Tuesday late morning in October means that they are depicted as being casual. In addition, the first screen 300 has navigation bar 320 and biometric graph 330. Navigation bar 320 comprises a plurality of features of the electronic device upon which the user is accessing the first screen 300 which is presented as part of a software system and/ or a software application (SSSA). Accordingly, due to the context determined by the SSSA these features are established to one or more conditions which are established by default and/or through user settings/modifications. For example, the first context results in wireless access being turned off (world image at top of list), camera turned off, and other features with button settings to the right hand side as well as some features such as biometric tracking (graph at bottom of list), clock, etc. being on. The context determined by the SSSA is determined from factors, including, but not limited to, date/time, user, geographic location, and biometric data. Biometric graph 330 depicts, for example, heart rate and a measure of brain activity derived from sensors associated with the user.

Accordingly, the context may be established therefore that the user is at school yielding the first screen 300 allowing the user to perform activities related to that context as they are essentially stationary in class or it may adjust based upon the determination that the user is now engaged within an indoor or outdoor activity, e.g. running, tennis, athletics, basketball, etc. and accordingly the feature set available to the user is adjusted such that the user can basically do nothing through the avatar interface or other interface and the SSSA focusses increased processing/datalogging capabilities to sensors associated either with the electronic device upon which the SSSA is in operation or other sensors, wearable devices associated with the user that are acquiring data relating to the user.

A range of wearable devices and sensors are depicted in FIG. 3B in first to fifth images 3000A to 3000E. Within embodiments of the invention these wearable devices and sensors may communicate with a body area aggregator such as the user s PED, for example. As evident from second screen 350 the user s avatar adjusts to display second avatar 360 and now displays enhanced biometric screen 370 that tracks additional aspects of the user based upon, for example, defaults of the SSSA and/sensors associated with the user. In this instance the second screen 350, second avatar 360, and enhanced biometric screen 370 are triggered by the user s context and activity as derived from the biometric sensor(s). Optionally, other variations may be presented such that for example a change in the time/date or geographic location may trigger an adjustment in the avatar for the user from first avatar 310 to second avatar 360. Alternatively, different activities of the user may trigger different associated elements of the display to the user.

Accordingly, referring to FIG. 3B there are depicted examples in first to third images 3000A to 3000C examples of current wearable devices including, but not limited to, smart watches, activity trackers, smart shirts, pressure sensors, and blood glucose sensors that provide biometric data relating to the user of said wearable device(s). Within first image 3000A examples of wearable devices are depicted whilst within second image examples of smart clothing are depicted. Third image 3000C depicts an example of a wearable device presenting information to a user in contrast to the devices/clothing in first and second images 3000A and 3000B respectively that collect contextual, environmental, and biometric data.

Smart clothing may be made from a smart fabric and used to allow remote physiological monitoring of various vital signs of the wearer such as heart rate, respiration rate, temperature, activity, and posture for example or alternatively it refers to a conventional material with embedded sensors. A smart shirt may, for example, record an electrocardiogram (ECG) and provide respiration through inductance plethysmography, accelerometry, optical pulse oximetry, galvanic skin response (GSR) for skin moisture monitoring, and blood pressure. Information from such wearable devices may be stored locally or with an associated device, e.g. smartphone, as well as being stored remotely within a personal server, remote cloud based storage, etc. and communicate typically via a wireless network such as Bluetooth, RF, wLAN, or cellular network although wired interfaces may also be provided, e.g. to the user's smartphone, laptop, or dedicated housing, allowing data extraction as well as recharging batteries within the wearable device.

Also depicted in FIG. 3B are fourth and fifth images 3000D and 3000E respectively of sensors and electronic devices providing biometric data relating to a user. For example, within fourth image 3000D a user s smart clothing provides data from sensors including, but not limited to, those providing acoustic environment information via MEMS microphone 3005, user breathing analysis through lung capacity sensor 3010, global positioning via GPS sensor 3015, their temperature and/or ambient temperature via thermometer 3020, and blood oxygenation through pulse oximeter 3025. These are augmented by exertion data acquired by muscle activity sensor 3030, motion data via 3D motion sensor (e.g. 3D accelerometer), user weight/carrying data from pressure sensor 3040 and walking/running data from pedometer 3045. These may be employed in isolation or in conjunction with other data including, for example, data acquired from medical devices associated with the user such as depicted in fifth image 3000E in FIG. 3B. As depicted these medical devices may include, but are not limited to, deep brain neurostimulators/implants 3050, cochlear implant 3055, cardiac defibrillator/pacemarker 3060, gastric stimulator 3065, insulin pump 3075, and foot implants 3080. Typically, these devices will communicate to a body area aggregator, e.g. smartphone or dedicated wearable computer. Accordingly, it would be apparent that a user may have associated with themselves one or more sensors, either through a conscious decision, e.g. to wear a blood glucose sensor, an unconscious decision, e.g. carrying an accelerometer within their cellphone, or based upon an event, e.g. a pacemaker fitted to address a heart issue.

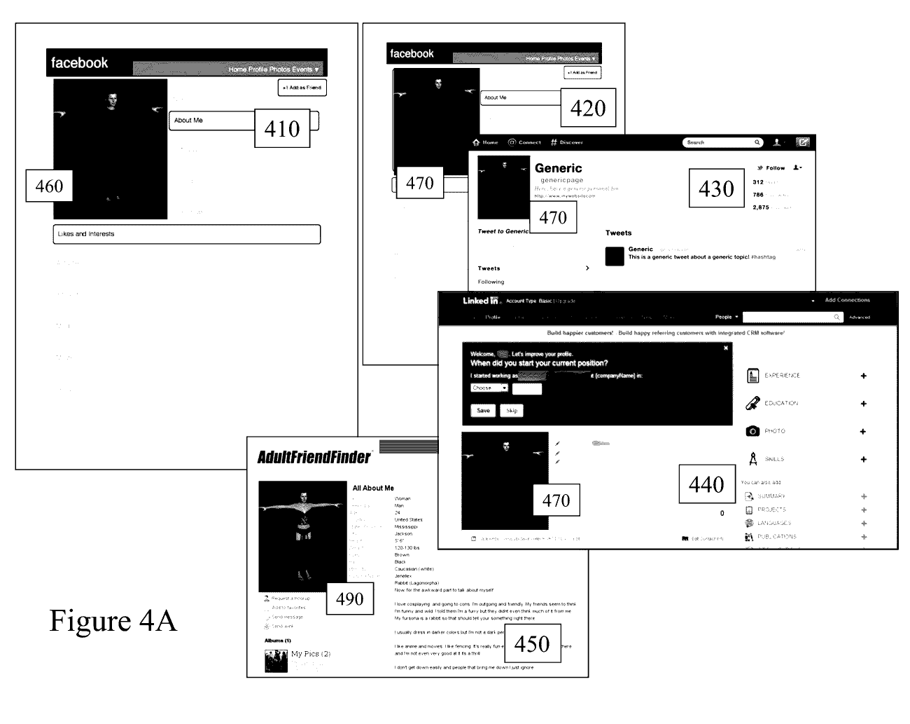

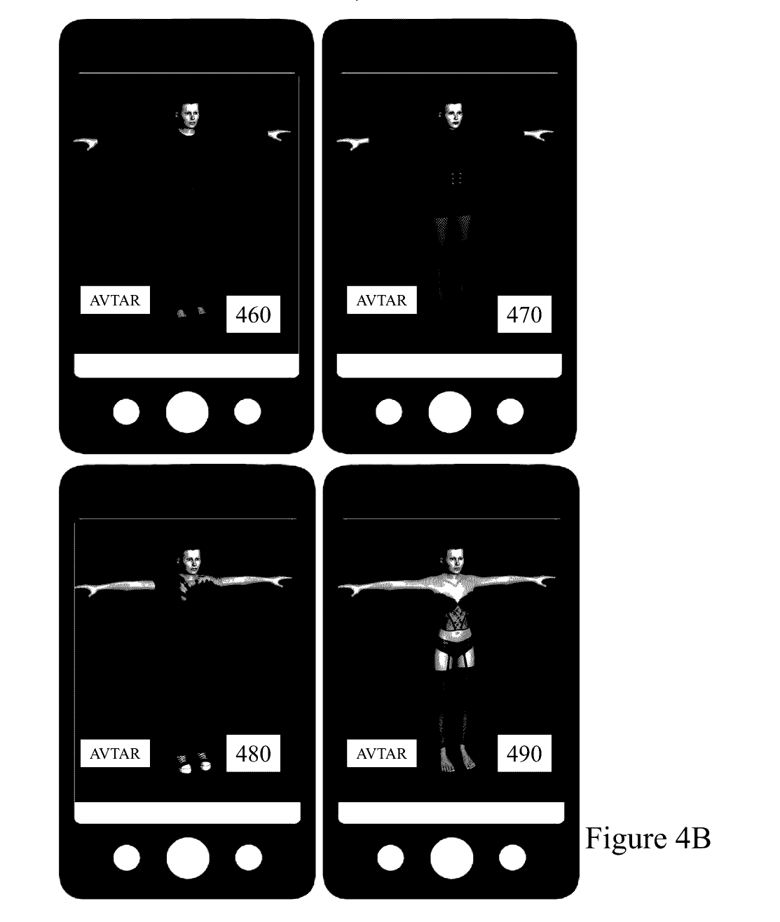

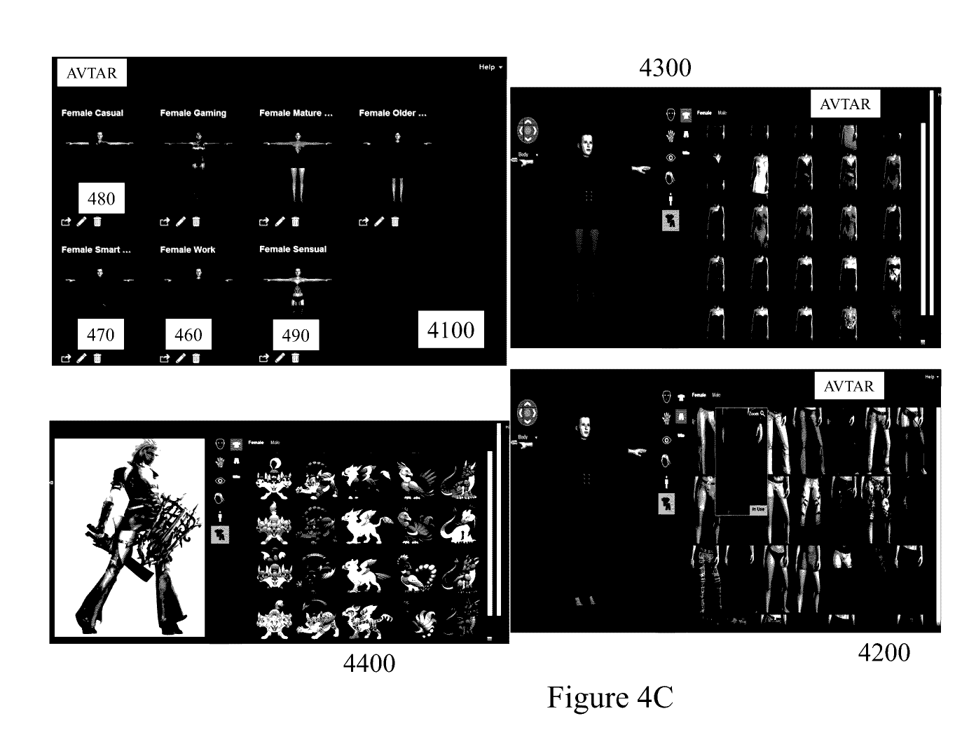

It would be evident from first and second avatars 300 and 350 respectively in FIG. 3A that the physical characteristics of the avatar are consistent but the clothing varies with the different avatars and hence contexts. Optionally, in addition to the clothing upon the avatar other aspects of the display may be adjusted such as background colour, background image, font, etc. The first and second avatars 310 and 360 respectively in addition to being displayed to the user through the SSSA in execution upon their PED and/or FED may also be depicted within their social profiles. For example, referring to FIG. 4A there are depicted first to fifth social media profile pages 410 to 450 for a user associated first to fourth context avatars 460 to 490 in FIG. 4B. These first to fourth context avatars, for example, being work, smart casual, casual and sexy. As depicted first social media profile page 410 is a Facebook™ profile is accessed for example by another user wherein the linkage of Facebook™ to the user's context is such that the first context avatar 460, work, is depicted to the individual upon viewing the first social media profile page 410. Subsequently, if the individual accessed the user s Facebook™ profile again at a later point in time where the user's context has changed to that associated with second context avatar 470, smart casual then they are presented with second social media profile page 420. Accordingly, at this point in time if the individual visited social media websites associated with Twitter™ and LinkedIn™ then they would be presented with third and fourth social media pages 430 and 440 respectively that each depict the second context avatar 470. Alternatively a user may restrict some social networks to one specific avatar, e.g. fourth context avatar 490, sexy, for specific social media/websites upon which they have a profile. In this example, fourth context avatar 490, sexy, is restricted by the user to a dating website, e.g. Adult FriendFinder™. Alternatively, certain avatars such as fourth context avatar 490 may be restricted automatically by the SSSA and social media/websites through the use of a factor such as an age filter, a content rating, etc. Accordingly, a context avatar associated with the user for adult presentation, e.g. fourth context avatar 490 or others similarly themed, may be exchanged for display upon a profile only if the social media/website is rated through a ratings system, presents a digital certificate, etc. Alternatively, the user may wish to limit the avatar on other social media/websites such as LinkedIn™ to first and second context avatars 460 and 470 respectively or just first context avatar 460. Such configurations may be set, for example, through the SSSA and user preferences.

The generation of the avatars such as first to fourth context avatars 460 to 490 respectively and first and second avatars 310 and 360 in FIG. 3 may be established through one or more processes. A first approach may be to prompt the user periodically to provide one or more images, e.g. a facial image, a body image, and the SSSA generates locally to the user's electronic device, or remotely upon a server, a base avatar which reflects the user at that point in time. This base avatar is then employed to generate the plurality of context avatars associated with the user either according to selections made by the user, as depicted in FIG. 4C, or according to user profile data for example. In the dynamic user selection such as depicted in FIG. 4C the user s baseline avatar is depicted as the plurality of context avatars based upon their previous choices of clothing. Hence, as depicted in screenshot 4100 the first to fourth context avatars 460 to 490 are depicted together with other context avatars. According the user may select one, e.g. second context avatar 470, smart casual, and be guided through a series of menu screens such as first and second screens 4200 and 4300 wherein the user can select aspects of the clothing, e.g. upper and lower body clothing in first and second screens 4200 and 4300 respectively. Other menu screens may allow other aspects such as footwear, headgear, accessories etc. to be selected.

The baseline avatar may be generated through capturing of a facial image via a camera within the user's electronic device upon which the SSSA is in execution. This may be a guided process wherein the user is directed to fit the central portion of their face to a template such that the images are acquired at a known scale. Similarly, front and rear body images may be captured through directed template image capture of the user. If the user wishes to include a nude context avatar then such baseline avatars may be captured with the user in the nude. Where the user does not wish to include a nude context avatar then they may take the baseline avatar image capture in underwear, body stocking, or other covering but figure templating item. Within another embodiment of the invention the baseline avatar is generated based upon the user's facial image and biometric profile data such as, for example, height, weight, gender, and ethnicity. Within another embodiment of the invention the baseline avatar is generated from a user selection of a database of avatars as they wish their baseline avatar to be a character such as one from fantasy, mythical, cartoon, and anime realms. As such the user may select from other menus such as depicted in FIG. 4400. Such avatars may be fixed within other contexts or may be similarly adapted in other contexts of the user. However, in all instances the avatar depicted upon the user s electronic device within the SSSA will be that reflecting the user's last update to their avatar and modified as required to the context they are in.

Optionally, the avatar may be modified in dependence upon the biometric data associated with the user and the current context. Accordingly, where the current context is “casual” and the biometric data indicates the user is running or jogging then the avatar may be “skinned” with an alternate selection, e.g. a pair of jogging pants and a t-shirt.

Within the descriptions of embodiments of the invention the avatar is described in some aspects of the invention as being presented to a user as part of an SSSA in execution upon their electronic device(s) wherein certain features/actions are associated with the avatar together with other displays, screens, information etc. Similarly, in other aspects of the invention the avatar is presented to other individuals, enterprises, etc. as part of SOCNETs/SOMEs, websites, webpages, etc. Within such externally accessed representations of the avatar some of the features/actions associated with the avatar for the user to whom it relates may be similarly provided whilst other features/actions associated with the avatar may be different to those for the user and may be only accessible to the other users. Within the descriptions below in respect of FIGS. 4A to 15 the display of the avatar is presented in respect of display screens, user screens etc. Accordingly, features described in respect of these Figures may in varying combinations be provided to users and other users through user interfaces, web interfaces, websites, web domains etc.

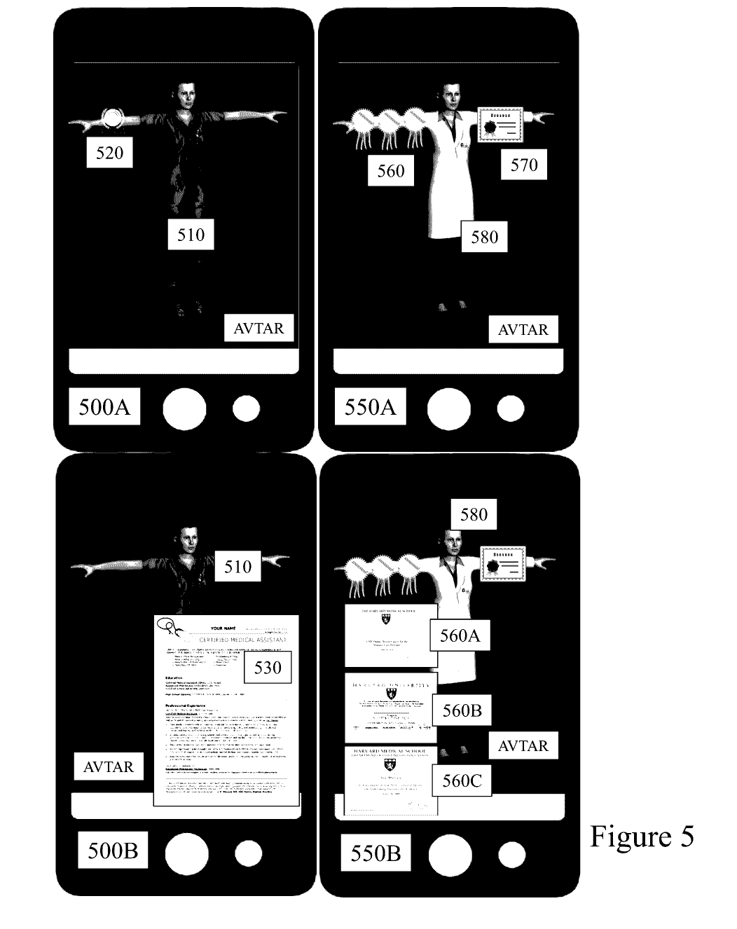

As discussed supra in respect of FIGS. 3A to 4C the user s avatar acts as part of an interface for the user and as an external avatar for use within other applications apart from the SSSA. Other features and aspects of the avatar interface will become evident from the descriptions below in respect of FIGS. 5 through 16. Referring to FIG. 5 there are depicted first to fourth SSSA screens 500A-500B and 550A-550B depicting avatar in evolving contexts according to an embodiment of the invention as may be presented with virtual and online environments associated with a woman user. Referring to first and second SSSA screens 500A and 500B the woman user is depicted as an avatar 510 in medical clothing, commonly referred to as scrubs, as the context associated with the first and second SSSA screens 500A and 500B is work and she is a medical nurse in training at this point in time. Associated with her avatar 510 in first SSSA screen 500A is an icon 520 which if selected results in the first SSSA screen 500A transitioning to second SSSA screen 500B wherein document 530 is displayed in association with the avatar 510. Document 530 in this instance presents the medical assistance experience of the user associated with the avatar.

Subsequently, the user completes additional activities, gains additional experience, etc. Accordingly, they amend their avatar clothing as depicted in third SSSA screen 550A yielding amended avatar 580 which is depicted now with icons 560 and certificate icon 570. Selection of icons 560 results in the user interface/website changing to fourth SSSA screen 550B wherein the icons 560 are now depicted as first to third certificates 560A to 560C respectively which represent the credentials acquired by the user, i.e. certificates of completing courses, etc. If instead the certificate icon 570 were selected the display would adjust to display the medical doctorate of the user. Accordingly, elements may be associated with an avatar that provides links to information about the user, in this instance, experience in their career. In some embodiments of the invention these links result in images being presented associated with qualifications, attributes, etc. whereas in others these may be hyperlinked images linking to content on a website or other websites similarly associated with the user. Such content may include, but not be limited to, a resume, user credentials, user qualifications, user experience, user publications, etc. as well as links to user employer, user website, user social media, user social networks, user biography etc. Optionally, different icons and/or elements (commonly referred to as gear) may be associated with the avatar to depict the different types of information, content, links, etc. available to the viewer/user for the avatar. In other embodiments of the invention such icons/gear may within a social network, for example, link to audiovisual content posted by the user to whom the avatar relates.

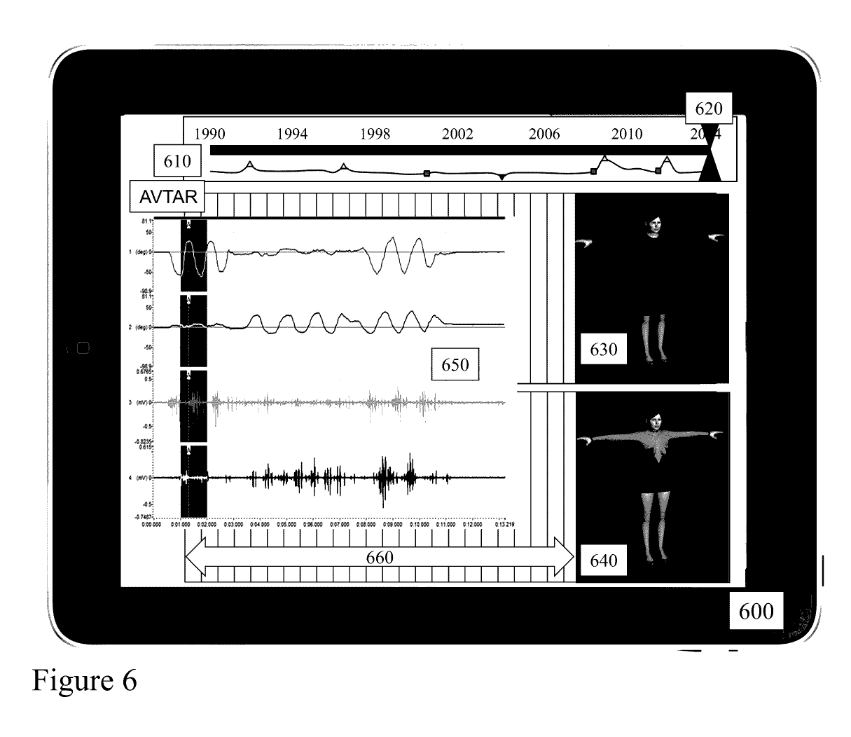

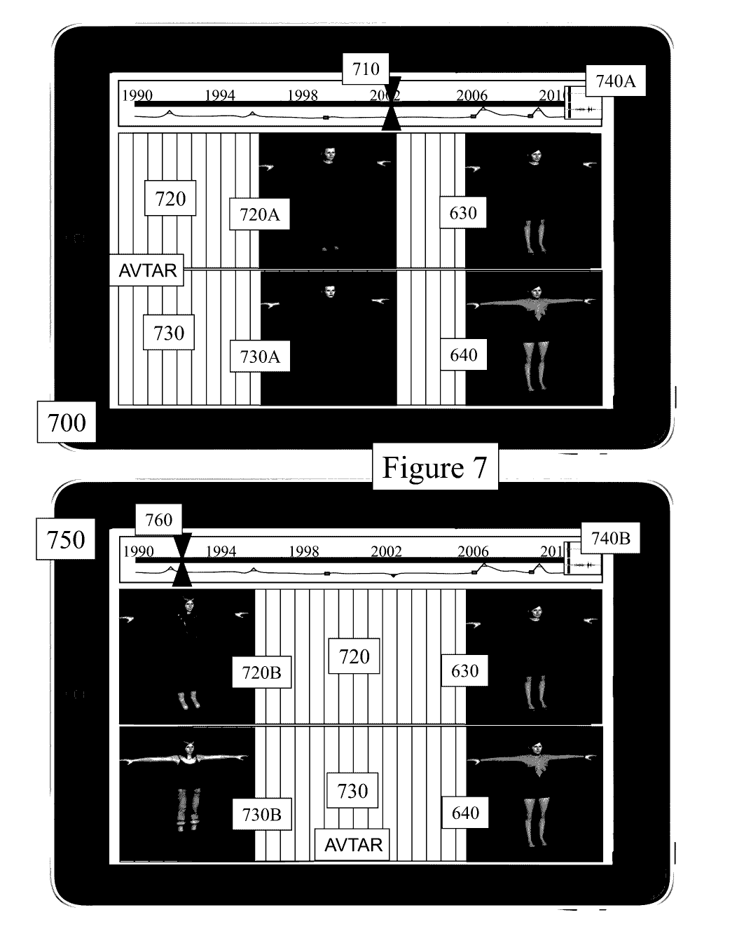

Referring to FIGS. 6 and 7 there are depict first to third avatar timelines 600, 700, and 750 associated with a woman according to an embodiment of the invention at different time points. Referring to first avatar timeline 600 in FIG. 6 a user screen is depicted comprising first and second avatar images 630 and 640 respectively for the user in two different contexts, e.g. work and smart casual respectively. Each of first and second avatar images 630 and 640 respectively are the final images in thumbnail filmstrips 660 which are displayed based upon the slider 640 on timeline 610 being set to the end of the timeline 610. Also depicted is biometric chart 650 representing a series of biometrics for a predetermined period of time with respect to the time associated with the slider 640 on timeline 610. If the user adjusts the slider 640 on the timeline then the screen transitions as depicted in second and third avatar timelines 700 and 750 in FIG. 7. As depicted in second avatar timeline 700 the slider has been moved back to 2002, depicted as first slider 710, and the user can view first and second context avatars 720A and 730A respectively within the first and second thumbnail filmstrips 720 and 730 respectively as well as first and second avatar images 630 and 640 which represent their current self.

As the user slides the slider further back, as depicted as second slider 760, to 1992 (approximately) then the first and second thumbnail filmstrips 720 and 730 respectively transition to display third and fourth context avatars 720B and 730B respectively together with first and second avatar images 630 and 640. Optionally, the user may in either instance of second and third avatar timelines 700 and 750 select either of first and second biometric icons 740A and 740B respectively wherein a biometric graph similar to biometric chart 650 is displayed representing the user biometrics of the user at the point in time associated with the timeline at the position of the slider. In this manner the user may view their physical and biometric evolution relative to their current physical appearance and biometrics.

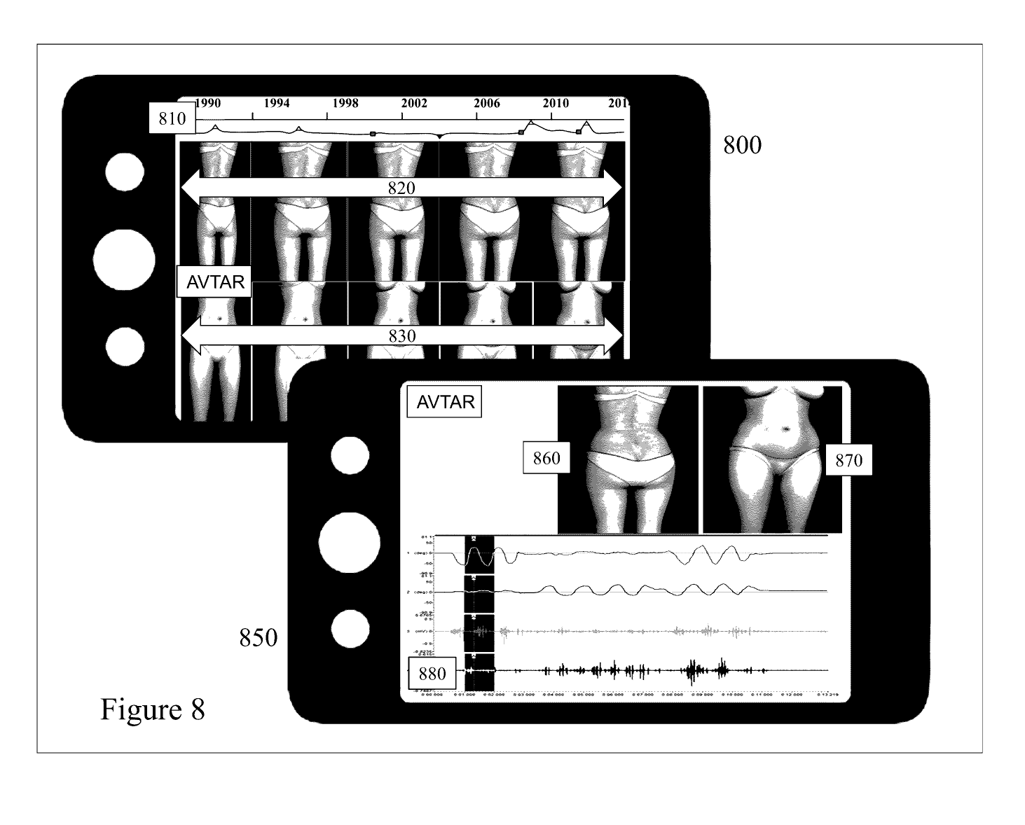

Referring to FIG. 8 there are depicted first and second screens 800 and 850 respectively depicting an avatar interface associated with a woman according to an embodiment of the invention. In first screen 800 the avatar interface is depicted as presented first and second thumbnail filmstrips 820 and 830 respectively for the user over a period of time shown by timeline 810 which includes against the time axis a key biometric of the user, e.g. weight. The first and second thumbnail filmstrips 820 and 830 respectively depict a number of avatar images for the user across the period of time denoted by the timeline. In this instance the first and second thumbnail filmstrips 820 and 830 respectively are front and rear user images captured at different times as described above in respect of defining the user's avatar. Selection of an image within either of the first and second thumbnail filmstrips 820 and 830 respectively triggers second screen 850 wherein the front and rear user images at that time point are depicted as first and second image 860 and 870 whilst a biometric graph 880 associated with the user at that point in time is displayed. The user may adjust the timeline 810 wherein the first and second thumbnail filmstrips 820 and 830 respectively change to reflect the new timeline 810. In this manner, the user may track aspects of their body image, biometrics, physiology, etc. over an extended period and establish characteristics that require addressing, require reinforcing, etc.

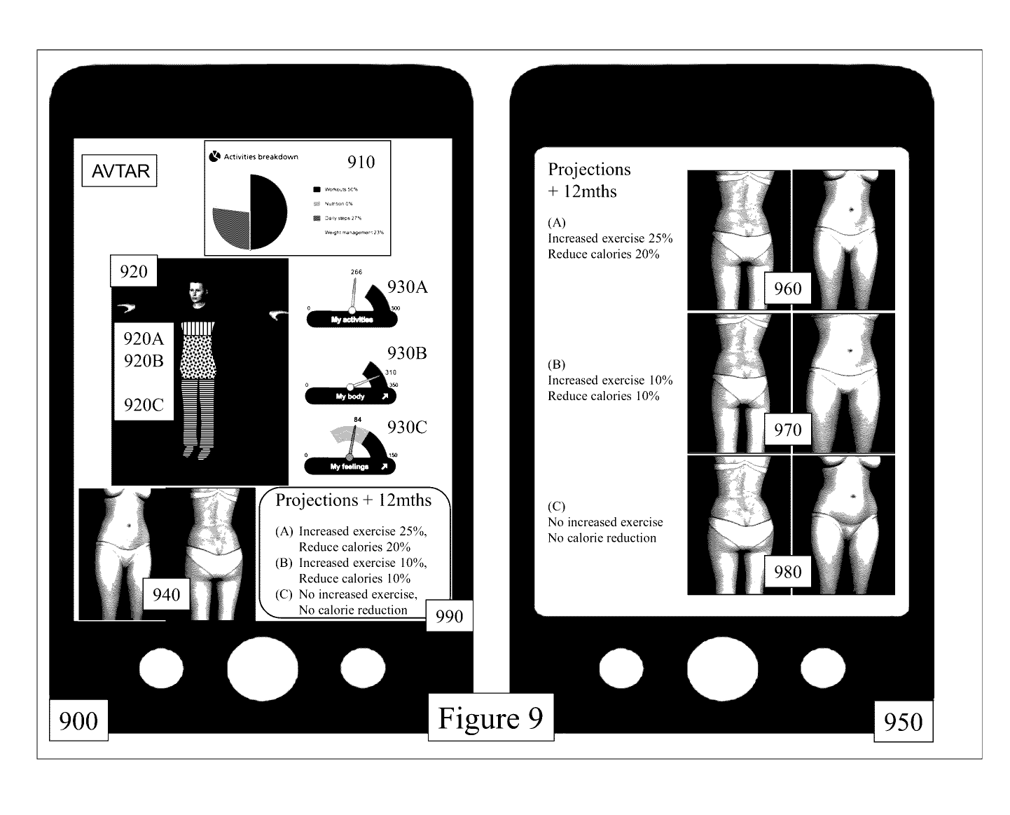

Now referring to FIG. 9 there are depicted first and second display screens 900 and 950 respectively for an avatar nutritional interface associated with a woman according to an embodiment of the invention at different time points and predictive avatar based outcomes of decisions. In first display screen 900 the user's avatar 920 is depicted with overlaid elements 920A to 920C that are associated with first to third indicators 930A to 930C which relate to the user's activities, body, and feelings. As each of these increases towards the target level then so do the corresponding overlaid elements 920A to 920C such that meeting target on all 3 results in the user's avatar 920 being overlaid completely. Also depicted is an activity breakdown graph 910 which is established in dependence upon the user touching the first indicator 930A. Touching the second and third indicators 930B and 930C respectively results in the presentation of corresponding graphics replacing activity breakdown graph 910 for these selected aspects of the user. Also depicted are front and rear user images 940 together with projection window 990 that provide a series of predictions to the user based upon their current physical and biometric data. In this instance, these projections relate to the adjusting their lifestyle in two scenarios and doing nothing in the third. If the user taps the projection window 990 then the display adapts to second display screen 950 wherein the SSSA has generated front and rear avatar images based upon the current avatar images and the three scenarios. These are depicted as first to third image pairs 960 to 980 respectively.

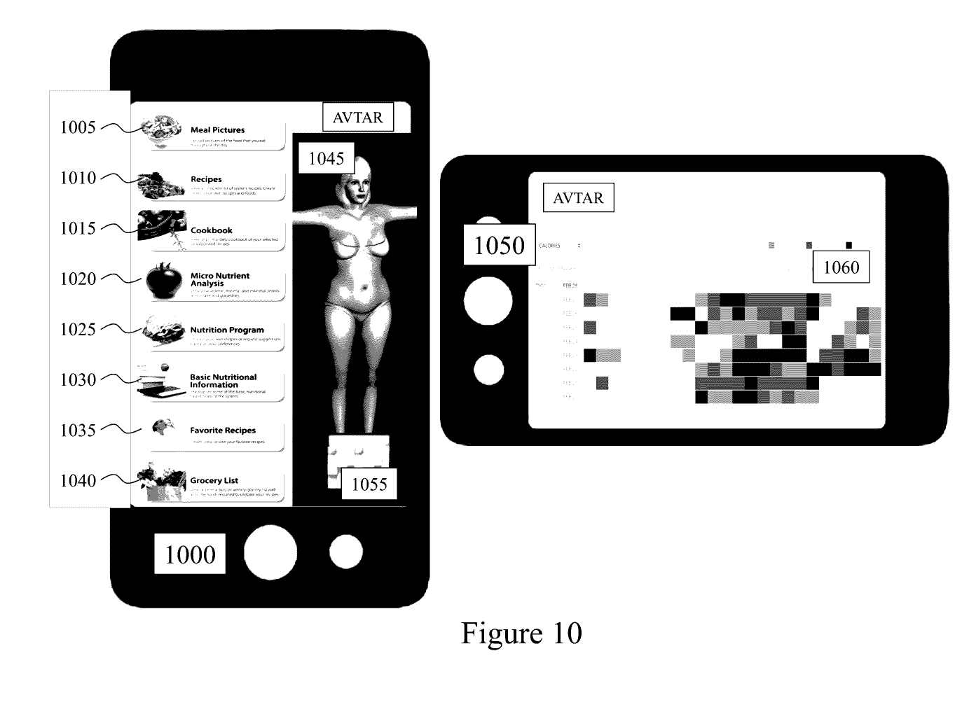

The user may access through the SSSA as depicted in FIG. 10 an avatar nutritional interface. As depicted in first and second display screens 1000 and 1050 according to an embodiment of the invention. As depicted first display screen 1000 presents the user with first to eighth nutrition options 1005 to 1040 respectively together with avatar 1045 and nutrition link 1055. First to eighth nutrition options 1005 to 1040 respectively being meal pictures, recipes, cookbook, micro-nutrient analysis, nutritional program, basic nutritional information, favorite recipes, and grocery list. Accordingly, the user may manage aspects of their diet by establishing recipes, analyzing their nutritional benefit, bookmarking favorites, and establishing a grocery list. The SSSA may in response to a user selection of a course of action, e.g. in response to a projection window and avatar projections such as depicted and described in respect of FIG. 9, establish an activity and dietary regimen for the user wherein a menu plan is provided, the grocery list generated (and in some embodiments of the invention ordered online for delivery), and the recipes provided to the user. Nutrition link 1055 results in the generation of one or more nutritional graphs such as nutrition mapping 1060 as part of second display screen 1050 wherein calorific intake of the user is plotted for different days as a function of time within the day. In this manner the user may adjust dietary patterns towards those supporting their target or to reflect other aspects of their lifestyle such as work, study, exercise etc. Optionally, the user may be presented with a drop-down menu (not shown for clarity) within second display screen 1050.

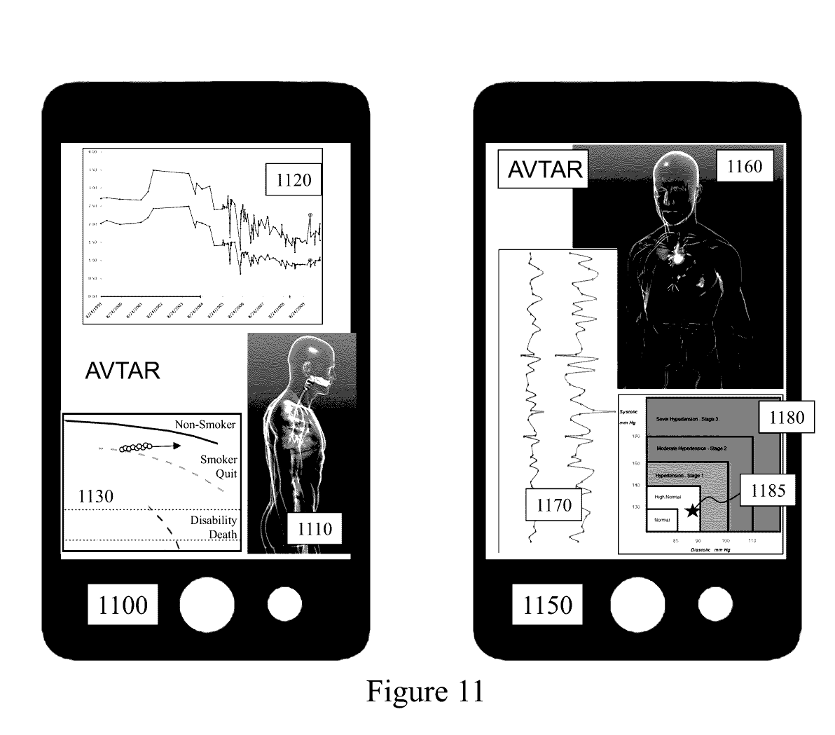

Now referring to FIG. 11 there are depicted first and second user screens 1100 and 1150 relating to an avatar based medical interface according to an embodiment of the invention. First and second user screens 1100 and 1150 respectively depict respiratory and heart aspects of the user within the avatar based medical interface. Accordingly, within first user screen 1100 there are depicted respiratory schematic 1110 together with first and second graphs 1120 and 1130 respectively. Respiratory schematic 1110 may depict coded data acquired from biometric sensors, wearable devices, etc. which may be numeric, pictorial, colour coded, etc. For example, deviations from normal respiratory behaviour within the context of the user may be coded as well as one or more of the actual current respiratory characteristics monitored, e.g. volume inhaled, rate of breathing, blood oxygenation, carbon dioxide exhalation, etc. The first and second graphs 1120 and 1130 are historical biometric and demographic biometric graphs respectively. Accordingly first graph 1120 depicts the historical respiratory performance of the user which in this instance indicates normalized profiles for respiratory rate and lung expansion indicating that the user's breathing has become easier with time. The basis of this is more evident in second graph 1130 wherein the user's data is plotted onto a demographic graph for users of same age/sex as the user but wherein they never smoked, quit as has the user, quit when disability occurs, and never quit. Accordingly, the upper dashed curve for users that have quit shows the normal reduction in lung performance with time whereas the user's data indicates an improvement above this curve arising from other adjustments in live style, diet, exercise regimen etc. as suggested, monitored, and tracked by the SSSA and reported to the user through their standard avatar and variant avatars such as medical avatar 1110.

Second user screen 1150 depicts a similar combination of data to the user for heart related aspects of the user within the avatar based medical interface. Accordingly, they are presented with pulmonary schematic 1160 together with third and fourth graphs 1170 and 1180 respectively. Pulmonary schematic 1160 in addition to indicating the primary pulmonary systems of their body may depict coded data acquired from biometric sensors, wearable devices, etc. which may be numeric, pictorial, colour coded, etc. For example, deviations from normal heart rate, blood oxygenation, etc. may be coded as well as one or more of the actual current respiratory characteristics monitored, e.g. actual heart rate, blood volume pumped, blood oxygenation, etc. The third and fourth graphs 1170 and 1180 are historical biometric and demographic biometric graphs respectively. Accordingly third graph 1170 depicts systolic and diastolic blood pressure data for the user over a period of time that can be moved by the user to depict different time periods, time spans, etc. Fourth graph 1180 depicts the user's time averaged systolic and diastolic blood pressure data 1185 onto a demographic chart, fourth graph 1180, for users of the same demographic as the user indicating that the user has what is termed “High Normal” blood pressure. Accordingly, the SSSA through accessing additional content relating to the increased blood pressure of the user may provide reference materials to the user as well as dietary, exercise, and nutritional variations designed to adjust their blood pressure over a period of time dependent upon their blood pressure relative to normal for example. Accordingly, the user with high normal may be presented with a series of small steps designed to adjust their blood pressure whereas a user with blood pressure in Hypertension Stage 1 may be given more substantial adjustments to reduce their blood pressure quicker initially before extending the adjustments as the user's blood pressure becomes closer to normal.

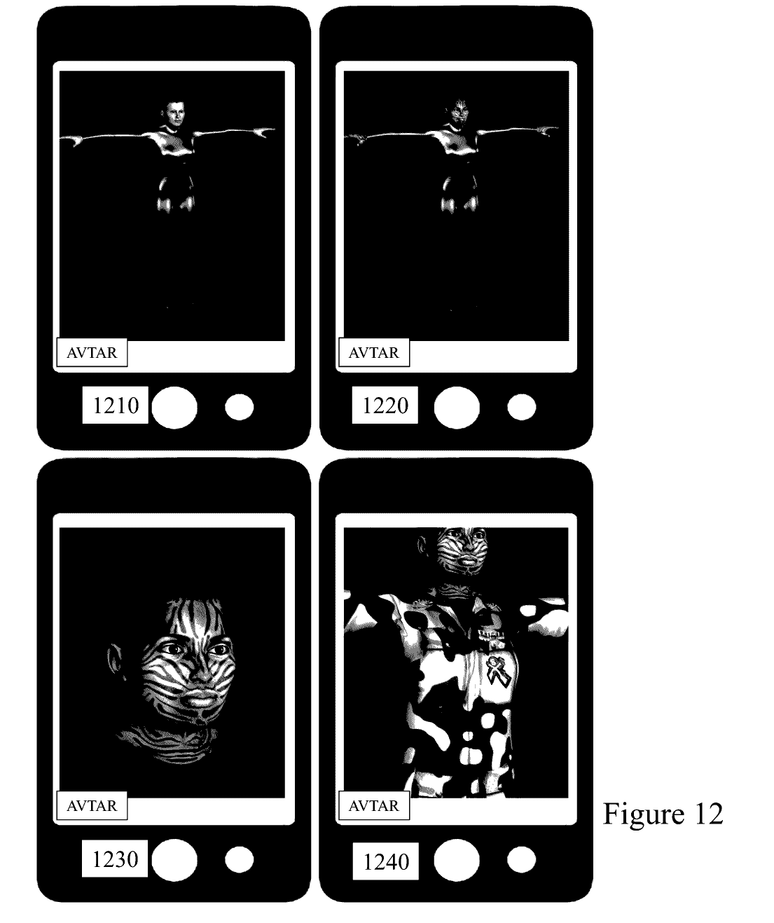

With the capture of image data relating to the user to generate their avatar within the SSSA alternate avatars may be generated within other virtual environments other than the user's SSSA, SOCNETs, SOMEs etc. For example, the user may be embedded into gaming environments based upon the insertion of their personal avatar rather than the display of an avatar within the game. Accordingly, as depicted in FIG. 12 the adaptation of an avatar based interface to online gaming environments according to an embodiment of the invention is depicted by first to fourth display screens 1210 to 1240 respectively. In first display screen 1210 the user's avatar has been “clothed” in a one piece suit determined, for example, by the environment of the game, other player clothing etc. In this instance, perhaps the game is a futuristic one. The user in this instance appears with their body and head whereas in second and third display screens 1220 and 1230 the user has had their skin tone adjusted through the gaming software to match the characteristics of the character that they are playing. However, as evident in second display screen 1220 their clothing is still the same as is their body. In fourth display screen 1240 the user's clothing is now adjusted to a military uniform to reflect the game they are playing whilst their skin tone has been adjusted but their physical profile in terms of face, hair, physical characteristics remains that defined by their baseline avatar. Accordingly, a user may insert their avatar into a game, where the game provides for this feature, and may depending upon the features within the software adjust their skin tone, adjust their clothing or have these aspects automatically manipulated by the gaming software. These concepts may be extended such that the characteristics of the character that the user is playing within the game may be adjusted in respect of the user's personal characteristics as defined by their SSSA avatar and profile/biometric data relating to the user. Accordingly, when running within a game the character may be slower/faster according to the characteristics of the user or their stamina may be adjusted or their ability to hold their breath adjusted based upon their respiratory characteristics. Such restrictions may require therefore the user in playing the game to adapt to new strategies, establish new solutions, etc. to the problems presented to them during the game. In other embodiments the complexity of logic puzzles, etc. may be adjusted to the mental characteristics of the user or their skills limited/expanded based upon their real world characteristics.

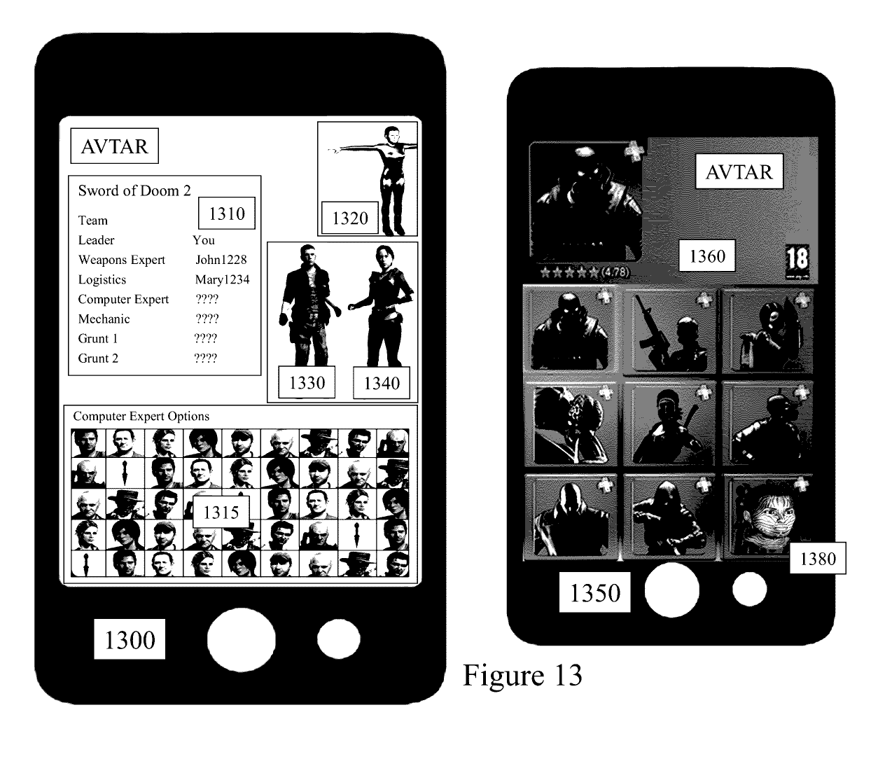

Accordingly, these concepts may be extended into gaming within multiplayer environments such that as described in respect of FIG. 13 in first and second screens 1300 and 1350 a multiplayer gaming team may be established in dependence upon the characteristics of the user's registered with the game. Accordingly, in first screen 1300 the user is establishing a team for “Sword of Doom 2” as indicated by team composition 1310. The user's gaming avatar is depicted as first image 1320 whilst the team members currently selected are presented as second and third images 1320 and 1330 respectively representing the “Weapons Expert” and “Logistics Expert” respectively. Next the user is selecting a computer expert which results in image wall 1315 being presented with other gaming community members who have profiles/skills aligning with the requirements of the “Computer Expert.” The user mat select an image within the image wall 1315 and be presented with a gaming profile based upon the avatar of the gaming community member which presents their skills, characteristics etc. within the framework of the game. Accordingly, the user may subsequently select the user they wish to add and they join the team. Joining the team may be automatic within some embodiments of the invention as the users on the image wall 1315 are those currently not playing within a team or the player is playing single player mode. In other embodiments of the invention the selected user may be invited to join. Accordingly, embodiments of the invention provide for establishing a gaming group based upon avatars associated with users wherein the avatar characteristics are based upon real world aspects of the users to whom the avatars are associated.

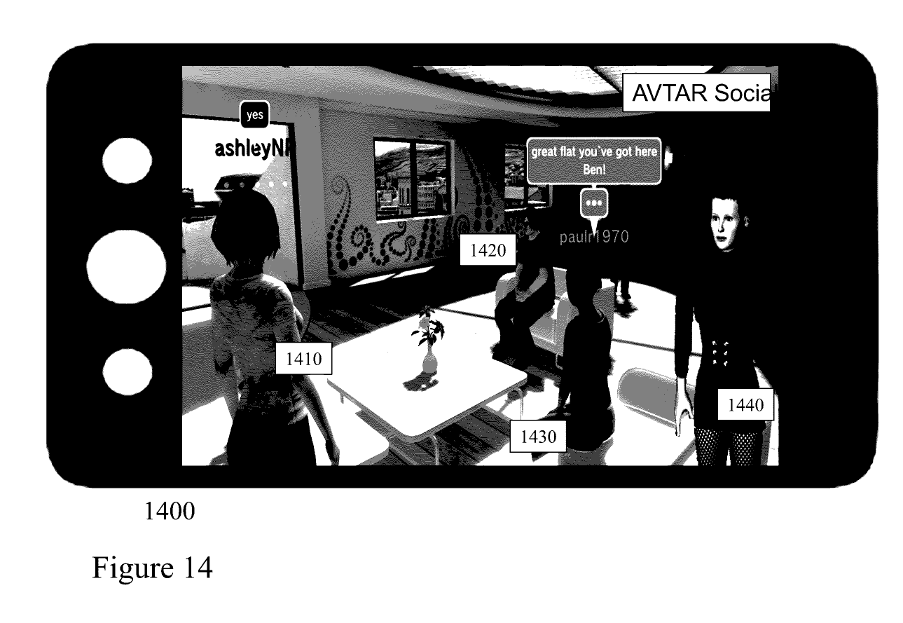

Similarly, in second display screen 1380 the user finds their avatar 1380 listed as part of a team selection screen 1360. These concepts can be further extended as depicted in FIG. 14 wherein the concept of virtual avatars mapping to real world users is presented within a virtual social community. Accordingly, the user is presented with display screen 1400 representing an environment within a virtual world comprising first to third users 1410 to 1430 respectively together with user avatar 1440 which represents the user in their smart casual context. Within embodiments of the invention the user's avatar may adjust to reflect their current context as this presents a visual indicator to the other users as to the user's current context. Accordingly, if the user's avatar is depicted in a work context then other users may appreciate why their question has a delayed response as the user is working whereas in casual context they might expect a quicker response. In other embodiments of the invention the user context may be limited to a subset of the contexts defined by the user or as determined by the virtual world application within which the user is seeking to engage. Accordingly, an adult community may establish through exchange with the user's profile whether they are old enough and based upon such a determination employ an avatar appropriate to the user's context. As such during the daytime the user may wish to appear in casual clothing whilst at night they wish to appear in a sexy context. Optionally, the use of a racy, sexy, or adult themed avatar may require explicit user authentication for use and without this an avatar of the user may be employed such as a default to a casual context avatar.

Within other embodiments of the invention the images acquired by the SSSA in respect of the user may be compared to imaged accessible to the SSSA such as user's driver's license, SOCNET image, SOME images etc. to provide verification that the user has entered accurate images. Such authentication of user physical appearance may also be provided to an online environment such that the authentication may be visible to other users so that they have improved confidence that the avatar with which they are interacting represents the user in reality. Optionally, such authentication may include the redaction/extraction of an image of the user acquired from a photographic identity document. In this instance the user may be required to provide a copy of an item of photographic identity to a remote server supporting the SSSA environments wherein it is redacted and compared without the user's interaction.

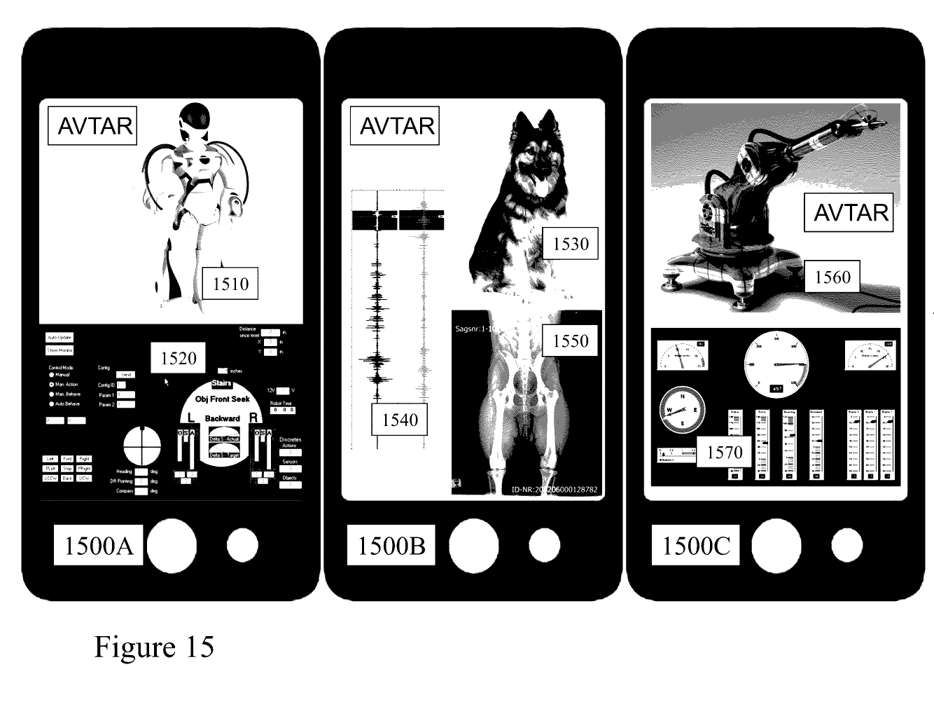

Within the descriptions supra in respect of FIGS. 1 to 14 the embodiments of the invention have been described with respect to a human user. However, as evident in FIG. 15 the application of avatar based interfaces according to embodiments of the invention may be applied to non-human elements. Accordingly, as depicted in FIG. 15 SSSA interfaces with avatar based elements are depicted in first to third display screens 1500A to 1500C respectively representing an android, an animal, and an industrial robot. The avatar interface may therefore adjust to other users such as described supra to reflect a context, environment, state of the element to which the avatar refers. It would be evident that the interfaces may present biometric data within a wider context such as for example, available power, hydraulic pressure, computing resources, etc. for the android. In some embodiments of the invention therefore sensors and wearable devices as described as capturing information relating to the user may become sensors and wearable devices worn, embedded or attached to an animal. Within mechanical systems such sensors and devices may be part of the assembly or they may be added to augment those actually monitoring the element.

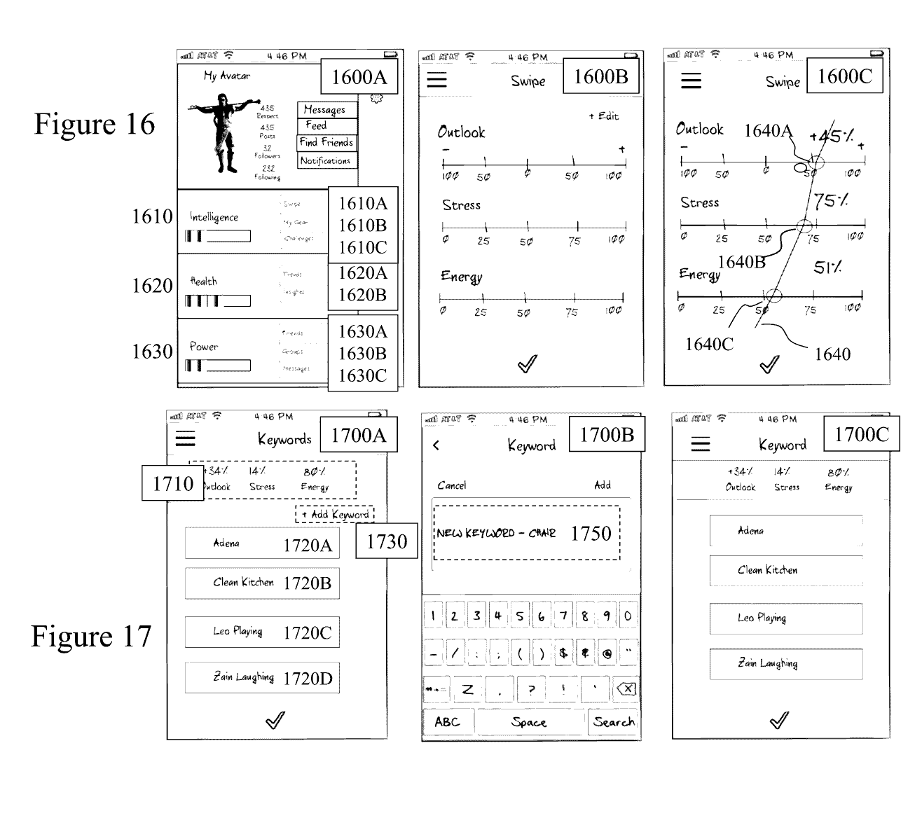

Now referring to FIG. 16 there are depicted first to third screen images 1600A to 1600C respectively for an avatar interface for a user according to embodiments of the invention. First screen 1600A depicts a summary/navigation screen to a user comprising first to third fields 1610 to 1630. First field 1610 relates to the user's avatar and as shown allows them to access through selection of the appropriate first to third selectors 1610A to 1610C the swipe interface, as described further in respect of FIG. 16, their gear which is described below in more detail but has also been described supra in respect of items associated with the user and displayed on their avatar, e.g. awards, credentials, certificates, skills, attributes, etc., and challenges offered/given. Each of the first to third selectors 1610A to 1610C may indicate additional information, such as for example third selector 1610C in respect of challenges may indicate the number of pending challenges relating to the user and the number of challenges outstanding with other users through SOCNETs/SOMEs/etc. that the user has issued but are not completed by the challenged party.

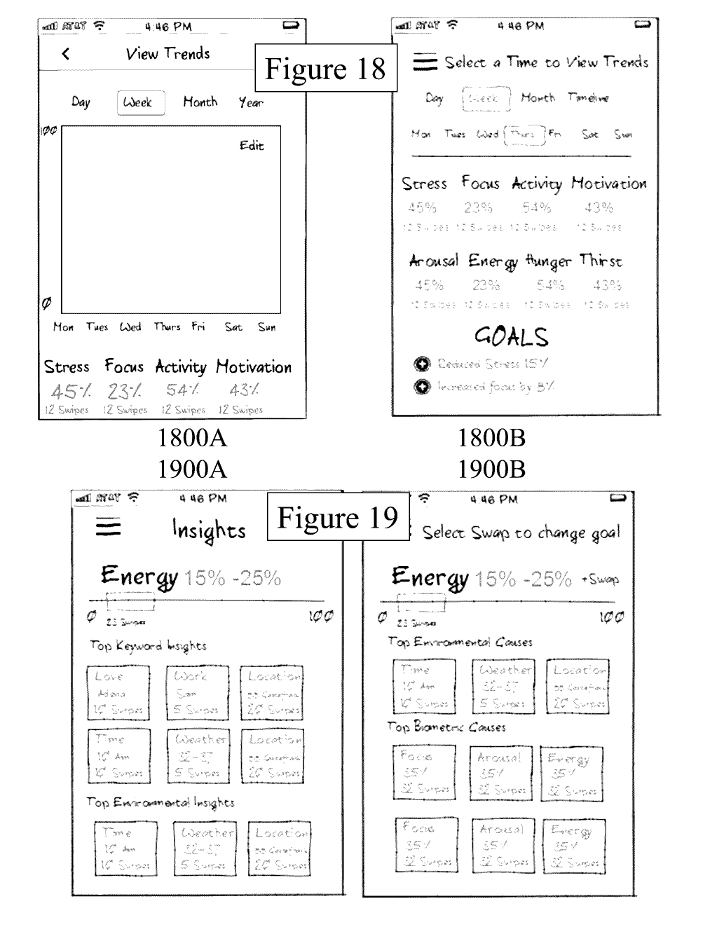

Second field 1620 relates to the user's goals and comprises fourth and fifth selectors 1620A and 1620B relating to trends (see below in respect of FIG. 18) and insights (see below in respect of FIG. 19). Third field 1630 relates to the user's feed comprises sixth to eighth selectors 1630A to 1630C relating to friends, groups, and messages. Each of the fourth and fifth selectors 1620A and 1620B and sixth to eighth selectors 1630A to 1630C may indicate additional information to the user. For example, trends in fourth selector 1620A may indicate a trend in respect of a biometric aspect of the user whilst eighth selector 1630C may indicate the number of pending messages.

Where the user selects first selector 1610A in respect of “swipe” then this transfers the user to second screen 1600B wherein a series of parameters relating to the user are depicted with graphical indicators. In this instance the parameters are outlook, stress, and energy but it would be evident that others may be presented or that a varying number may be presented. Accordingly, the user as depicted in third screen 1600C the user makes a continuous swipe down the screen such that their finger crosses each parameter at a point representing their current view of that parameter wherein the SSSA determines the crossing point, e.g. 45% for outlook which has a range −100 Outlook≦100, 75% for stress which has a range 0≦Stress≦100 , and 51% for energy which has a range 0≦Energy≦100. Optionally, parameters may have additional indicators such that, for example, outlook may be displayed as “sad” on the left and “happy” on the right. The resulting assessments are then stored and employed either in assessments such as insights or trends. In this manner the user can enter rapidly multiple data points rather than using multiple discrete sliders such as known in the prior art.

Upon completing third screen 1600C the user is presented with first screen 1700A in FIG. 17. Accordingly, the user may select a parameter, e.g. “outlook”, from parameter list 1710 wherein different terms are presented in fields 1720A to 1720D. These terms may, for example, represent the highest frequency terms for the user for that parameter within which their swipe assessment sits. Alternatively, these may, be selected by the SSSA or be terms established from a SOCNET/SOME etc. for other users with the parameter in a similar position. If the user feels on the terms matches their current feeling then they may select it or several of them. If the user wishes to add a term then they may select “add” 1730 which results in the screen transitioning to second screen 1700B allowing the user to start typing a term which if it occurs in a database results in it appearing in field 1750. If the term is not present then the user can complete its typing and select to enter it as a new context term. Once the user has completed the association of terms with each parameter then they are presented with summary screen, third screen 1700C. In this manner a user may associate terms to their feeling at the time that they complete the swipe. Hence, if the user is feeling a high level of stress then they may associate terms such as “work”, “boss”, “money” in many instances but in others may associate “wife”, “money”, “weight.” Accordingly, where terms appear with frequency they can form the basis of triggering actions or information to the user.

Now referring to FIG. 18 there are depicted first and second screen images 1800A and 1800B respectively for an avatar interface for a user relating to trend views for different aspects of the user according to an embodiment of the invention. These first and second screen images 1800A and 1800B respectively are accessed, for example, via fourth selector 1620A in first screen image 1600A in FIG. 16. First screen 1800A depicts a trend for an aspect of the user over a period of time, e.g. day, week, month, etc. allowing them to view for example how their stress has adjusted over this period of time whilst also displaying the values of other parameters. In second screen image 1800B the user is presented with a view depicting the parameters they are tracking indicating their values over the period of time selected, e.g. an average, weighted average, maximum—minimum, average and standard deviation, etc. The user is then able to select one or more parameters and associate a goal to these. As depicted the user has indicated a desire to reduce stress by 15% and increase focus by 8%. These desires may then be employed within other aspects of the SSSA to provide prompts, content, advertisements, suggestions, etc. to the user as well as actions that will lead to the user achieving their goals.

Now referring to FIG. 19 there are depicted first and second screen images 1900A and 1900B respectively for an avatar interface for a user relating to insight views for different aspects of the user according to an embodiment of the invention. These first and second screen images 1900A and 1900B respectively being accessed, for example, via fifth selector 1630A in first screen image 1600A in FIG. 16.As noted supra a user may establish terms in association with their parameters, e.g. energy, outlook, sex drive, energy, etc. Accordingly, the user through first screen image 1900A may view their keyword insights and environmental insights. For example, the user has selected energy which is depicted with a range of 15%-25% and having made to date 23 swipes. As such the keyword insights are indicated that have occurred most frequently, e.g. love has been associated with 10 of the swipes, location with 20 of the swipes, and time in 10 swipes. The environmental insights show that time, weather, and location were the main determining factors to the feeling. In second screen image 1900B the user is presented with biometric causes for the parameter at this level.

Accordingly, the user can see the biometrics causes and similarly see what aspects of their biometrics when adjusted, may improve their energy level. It would be evident that in some instances the associations, for example, that of the time of low energy with their blood sugar level dropping an hour later provides the user with an ability to associate factors with causes and adjust aspects of their life. In each of first and second screen images 1900A and 1900B respectively the user may adjust the slider at the top of the screen and move the indicator to a different level and accordingly, the user can see the keyword, environmental, biometric insights associated with the different levels. In this way, the user can see, for example, what factors are associated with high energy levels and what are associated with low energy levels allowing them to, for example, establish actions that would lead to increased instances of the factors/terms associated with the more desirable level of the parameter.

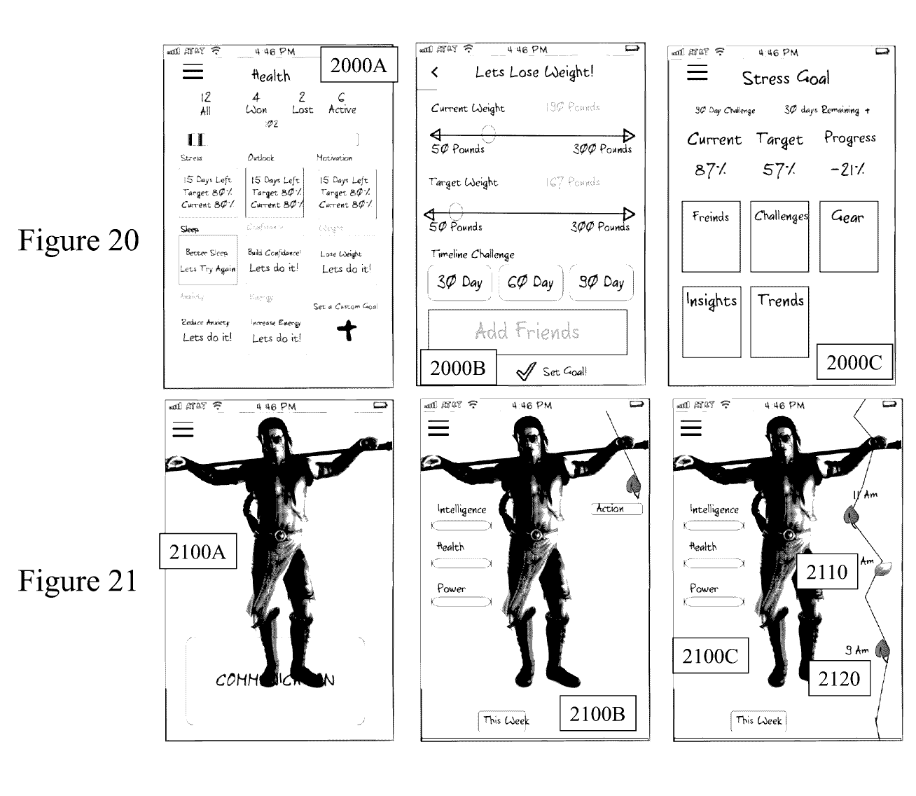

Now referring to FIG. 20 there are depicted first to third screen images 2000A to 2000C respectively for an avatar interface for a user relating to goal management screens according to an embodiment of the invention. As described supra a user may through analysis of terms, parameters, trends, insights, and other aspects of the invention establish an action or actions. Accordingly, the user may view their goals in first screen image 2000A which may, for example, be accessed by the user selecting “My Goals” in first screen image 1600A in FIG. 16. As depicted, the goals established are associated with parameters, e.g. stress, outlook, arousal, motivation, etc. Where the user has completed all actions associated with a parameter, e.g. arousal, then the action is shown completed. Other actions, e.g. motivation, may be not completed and depicted as such with a trigger to repeat. Other actions, e.g. stress, are still ongoing and are depicted with time remaining, target completion, and currently completed level. Other actions may be pending as placing too many actions on a user may reduce the likelihood that they complete any.

If a user wishes to add an action, e.g. for weight, then they are presented with second screen image 2000B wherein they are presented with their current weight, a slider to enter their target weight, and selectors to choose a target timeline for the action/challenge. The user may then opt to add friends so that their challenge/action is visible to their friends who may elect to set corresponding goals along with the user and/or provide support through engaging in activities with the user. Now referring to third screen image 2000C the user is presented with a display associated with a stress reduction goal, for example. This indicates the duration of the action, the time remaining, their current status and target together with icons for factors associated with friends, challenges, gear, insights, and trends. Selection of an icon leads the user to other screens including, for example, those associated with trends (as depicted in FIG. 18) and insights (as depicted in FIG. 19) as well as others not shown.

Now referring to FIG. 21 there are depicted first to third screen images 2100A to 2100C respectively for an avatar interface for a user according to an embodiment of the invention. In first screen image 2100A the user's avatar, such as generated, evolved, modified, etc. as described in respect of embodiments of the invention in respect of FIGS. 3 to 15 for example. Accordingly, the user is depicted with indicators, e.g. intelligence, health, and power derived from their entries as well as biometric data, where available, to augment their entered data. Communications from friends, etc. are presented within a window on the interface screen. In second screen image 2100B the user's avatar is depicted with additional data relating a timeline for the user's parameters although other timelines relating to actions/challenges associated with the user may also be depicted. The timeline can be scrolled through by actions on the touchscreen of the user's PED, for example, and as depicted in third screen image 2100C wherein the user has now changed the timeline base to weekly and indicators are shown. These may be dynamically generated by the SSSA, e.g. first indicators 2110, and others are associated with user actions, e.g. second indicators 2120. In each of second and third screen images 2000B and 2000C other icons allow the user to navigate to other elements within the SSSA including, for example, challenges, gear, and management of the overall SSSA environment.

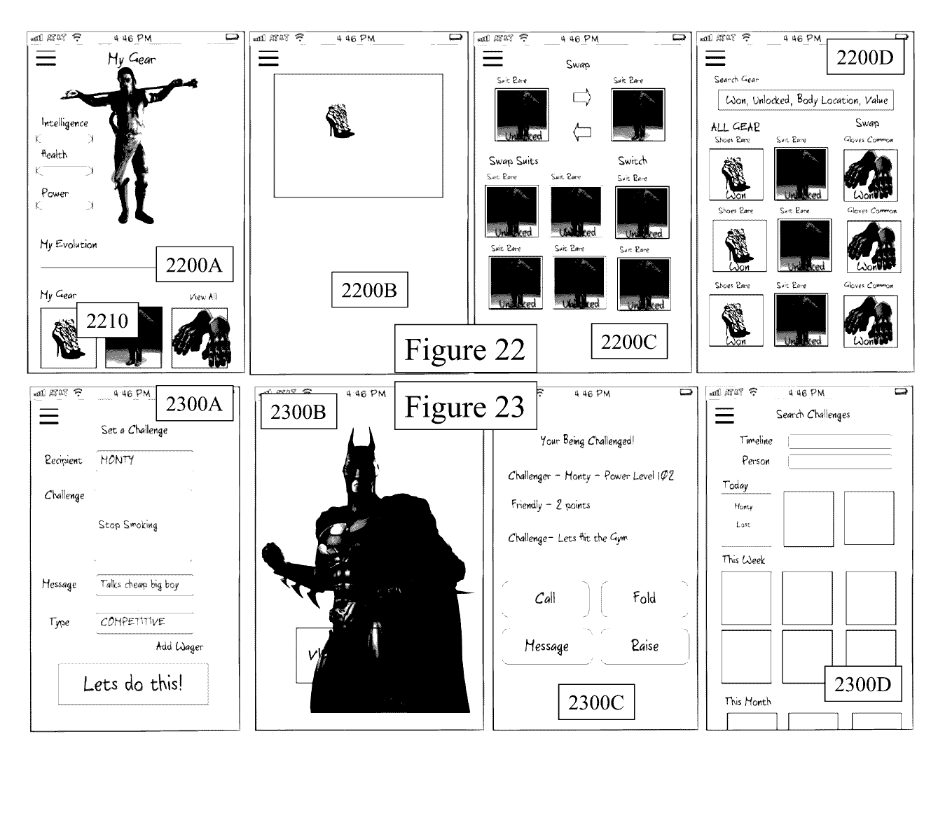

Now referring to FIG. 22 there are depicted first to fourth screen images 2200A to 2200D respectively for avatar interfaces for a user managing gear relating to their avatar according to an embodiment of the invention. In first screen image 2200A the user is presented with their gear, an evolution timeline, and a summary of the user's status. As the user moves the evolution marker, then as described supra the user's avatar adjusts to reflect their status at that point on the evolution timeline as do the markers associated with their parameters, e.g. intelligence, power, and health. Similarly, their gear adjusts and the user may select a specific item of gear, e.g. gear 2210, wherein second image is presented to the which, for example, indicates a description of the gear, attributes associated with the gear, and the history of the gear. For example, as depicted below in respect of FIG. 23 a user may issue challenges or be challenged with respect to an activity and accordingly in some instances may have won the gear through winning such a challenge.

Optionally, the gear was acquired by the user in respect of a goals achieved, real life achievements, etc. As the gear associated with an avatar for a user may, in some instances, be worn and displayed to the user and/or other users via the user's social media profiles etc. as described supra then the user may have more gear than can be worn or have incompatible gear. In these instances the user may through the user interface, such as third image 2200C for example, adjust the gear associated with their avatar either within a particular context, multiple contexts, single social networks and/or multiple social networks. Accordingly, in third image 2200C the user is swapping clothing to another suit. Displayed to the user are their options. In some embodiments of the invention the gear may be unlocked by completion of challenges, tasks, achieving goals, etc. If the gear owned by a user represents a large number of items or they wish to search for an item based upon one or more associations, terms, etc. then the user may exploit a gear search screen, such as depicted by fourth image 2200D, in order to search and display gear matching their search. The user may search, for example, for items worn, for items unlocked, by body location for the gear, and value. Accordingly, the acquisition and management of gear can form part of a “game” associated with the user's interfaces/social media etc. Accordingly, a user may seek to challenge friends to acquire additional gear or a user may wish to search for users based upon their gear where the gear may be chosen for the user.

Now referring to FIG. 23 there are depicted first to fourth screen images 2300A to 2300D respectively for avatar interfaces for a user with respect to challenges according to an embodiment of the invention. In first image 2200A the user has elected to issue a challenge to another user, in this case “Monty”, with the challenge to “Stop Smoking” and added a message and defined the challenge by one of a range of types available according to different basis including, but not limited to, user status, user rights, etc. The user has the ability to add a wager to the challenge which may for a reward which is within or external to the BIOSAP. Once the challenge has been issued then the user receiving the challenge is presented with second screen image 2200B indicating that they have received a challenge from another user, e.g. their friend “Monty”, who is also identified by their avatar identifier being displayed. Upon viewing the challenge the user is presented with third image 2300C wherein the details of the challenge are shown. In this instance there is no associated timeline for the challenge, although this may be optionally set, that it is a friendly wager worth 2 points, and that the user must “hit the gym.” The association of points allows a user to acquire these in respect of aspects of their avatar, e.g. these count towards energy, power, status, intelligence, etc. or they may be used in respect of buying, bidding, unlocking gear.

In some instance a mediator may be identified whilst in other instances the mediation may be automatic as it may be for example, validation of the user performing an action that may be verified through biometric data discretely or in combination with other data sources, e.g. GPS. The user may call the challenger, to chat, argue, smack-talk etc., message the user, accept, decline (fold), or may also reverse or adjust the challenge with the challenger through a “raise” option. The user may, as depicted in fourth image 2300D, view/search their challenges by timeline and/or individual, for example. They may also scroll through their challenges both issued and received.

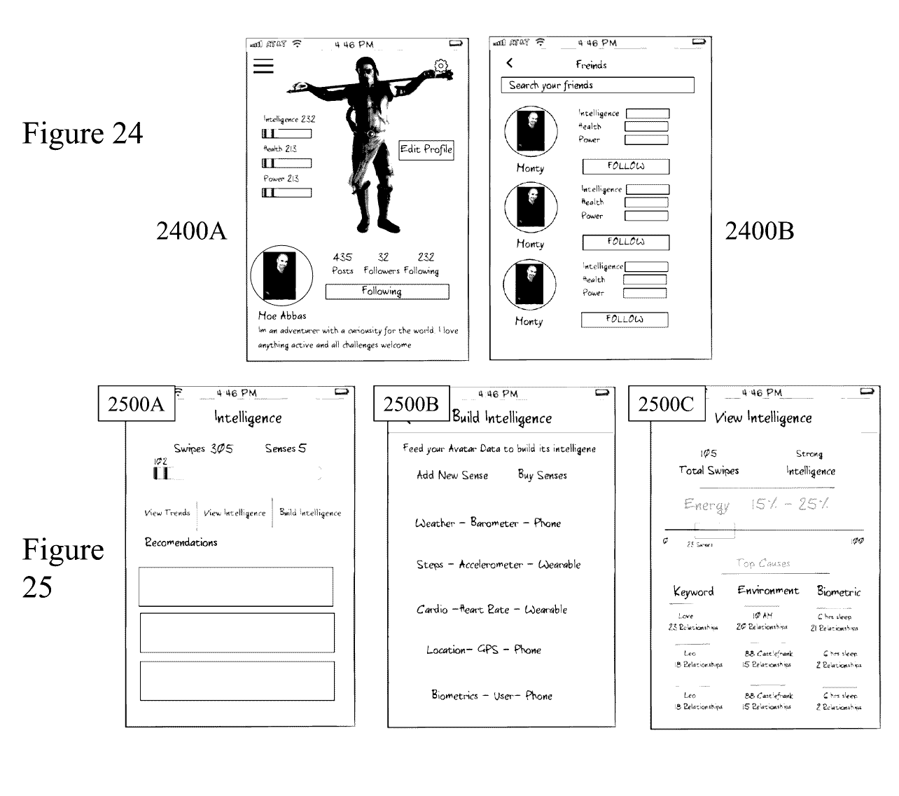

Now referring to FIG. 24 there are depicted first and second screen images 2400A and 2400B respectively for avatar interfaces for a user with respect to their profile and friends. In first image 2400A the user may view their profile as portrayed to other users within the BIOSAP and/or SOCNETs/SOMEs etc. The user may through a profile management screen, not displayed, adjust the information presented upon their profile page as well establish rules for the display of their contextually/biometrically defined avatar according to the embodiments of the invention. In second screen 2400B the user may search for friends and be presented with snapshot summaries as depicted wherein each profile can also then be viewed in detail, not shown, based upon selection of the user's profile picture. Displayed associated with each user in the search results or the user's contacts are the parameters of intelligence, health, power with their values according to the current profile of that user. Accordingly a user may wish to seek a friend with high intelligence and power. Optionally, these searches may as described supra include biometric matching/searching features according to embodiments of the invention.

Now referring to FIG. 25 there are depicted first to third screen images 2500A to 2500C respectively for avatar interfaces for a user with respect to building and viewing an aspect of their profile, e.g. intelligence. These images may be similarly displayed and employed by the user in respect of other characteristics of their avatar including, but not limited to, power and health. In first image 2500A the user is presented with a summary of their intelligence as a score together with the number of swipes and senses that they have. They are then able to view trends, view intelligence, and build intelligence, for example. They are also presented with suggestions by the BIOSAP which are determined upon the characteristics of the user, their history, their goals, etc. If the user elects to build intelligence then they may be presented with second image 2500B wherein the senses associated with the user are presented. In this instance, the user has 5 senses which are defined as “Weather—Barometric”, “Location—GPS”, and “Biometrics—User” as associated with their smartphone together with “Cardio—Heartrate” and “Steps—Accelerometer” which are shown as being associated with wearable's of the user. The user can within second image 2500B add a new sense and/or buy a sense (e.g. buy a new wearable or an enhancement/software upgrade for an existing wearable.)

In third image 2500C the user is presented with intelligence overview wherein they are also presented with the highest associations to the user's intelligence as established through their swipes. In this instance, these are depicted as keywords, environment, and biometric. Accordingly, the user can view the factors impacting their overall feelings in respect of intelligence although as evident from FIG. 16 the user may enter data for multiple aspects of themselves in a single swipe and may have associations for each of these or for combinations which are entered based upon their keyword selections/entries and displayed within similar viewing screens for these different characteristics. Optionally, multiple characteristics may be associated and displayed as 2D/3D representations including an ability to adjust the timeline manually or automatically over a predetermined range so that they can see how these characteristics have evolved.

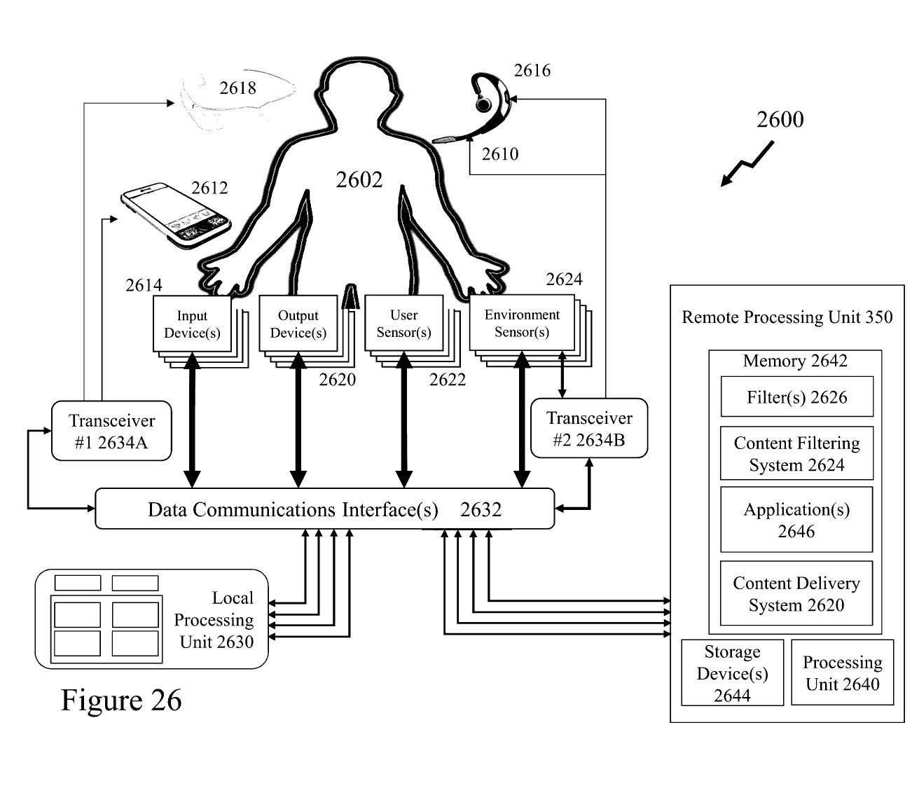

Referring to FIG. 26 there is depicted an exemplary implementation of an embodiment of the invention embodied as a wearable computer, local processing unit (LPU) 2630, for user 2602. The LPU 2630 interfaces to a variety of body-worn input devices, such as a microphone 2610, a hand-held flat panel display 2612, e.g. user's smart phone, and various other user devices. Examples of other types of input devices 2614 with which a user can supply information to the LPU 2630 include speech recognition devices, traditional qwerty keyboards, body mounted keyboards, digital ink devices, a mouse, a track pad, a digital stylus, a finger or glove device to capture user movement, pupil tracking devices, a trackball, a voice grid device, digital cameras (still and motion), and so forth. The LPU 2630 also interfaces has a variety of body-worn output devices, including the hand-held flat panel display 2612, an earpiece 2616, and a head-mounted display in the form of an eyeglass-mounted display 2618. Other output devices 2620 may also be incorporated into the LPU 2630, such as a tactile display, other tactile output devices, an olfactory output device, etc.

The LPU 2630 may also be equipped with one or more various body-worn user sensor devices such as user sensors 2622 and environment sensors 2624. For example, a variety of sensors can provide information about the current physiological state of the user and about current user activities. Examples of such sensors include thermometers, blood pressure sensor, heart rate sensors, skin galvanometry sensors, eyelid blink sensors, pupil dilation detection sensors, EEG and EKG sensors, sensors to detect brow furrowing, blood sugar monitors, etc. In addition, sensors elsewhere in the near environment can provide information about the user, such as motion detector sensors, accelerometers, temperature sensor, gas analyzer still and video cameras (including potentially low light, infra-red, and other non-visible wavelength ranges as well as visible ranges), ambient noise sensors, etc. These sensors can be both passive, i.e. detecting information generated external to the sensor, such as a heartbeat, and active, i.e. generating a signal to obtain information, such as sonar for example.

The LPU 2630 may also be equipped with various environment sensor devices 224 that sense conditions of the environment surrounding the user. For example, devices such as microphones, motion sensors, and ultrasonic ranging to determine whether there are other people near the user and whether the user is interacting with those people. Sensors, either body-mounted or remote, can also provide information related to a wide variety of user and environment factors including location, orientation, speed, direction, distance, and proximity to other locations (e.g., GPS and differential GPS devices, orientation tracking devices, gyroscopes, altimeters, accelerometers, anemometers, pedometers, compasses, laser or optical range finders, depth gauges, sonar, etc.). Identity and informational sensors (e.g., bar code readers, biometric scanners, laser scanners, OCR, badge readers, etc.) and remote sensors (e.g., home or car alarm systems, remote camera, national weather service web page, a baby monitor, traffic sensors, etc.) can also provide relevant environment information.

The LPU 2630 is coupled to the input devices 2614, output devices 2620, user sensors 2622, environment sensors 2624, hand-held flat panel display 2612, earpiece 2616, and glass-mounted display 2618 as well as other various inputs, outputs, and sensors are connected to the LPU 2630 via one or more data communications interfaces 2632 which may be implemented using wire-based technologies (e.g., wires, coax, fiber optic, etc.) or wireless technologies (e.g., optical, RF, etc.). First and second transceivers 2634A and 2634B receive incoming messages from the network 200 (not shown for clarity) and pass them to the LPU 2630 via the data communications interface(s) 2632. The first and second transceivers 2634A and 2634B may be implemented according to one or more industry standards and/or formats including, but not limited to, Wi-Fi, WiMAX, GSM, RF link, a satellite receiver, a network interface card, a wireless network interface card, a wired network modem, and so forth.

The LPU 2630 may include, for example, one or more microprocessors, memory, storage device, memory card interface, and a control interface, central processing unit (CPU) 240, a memory 242, and a storage device 244 such as described and depicted supra in respect of FIG. 2. Additionally, a remote processing unit (RPU) 2650 is also connected to the data communications interface 2632. Within the embodiment presented in FIG. 26 the RPU 2650 is depicted as comprising a processing unit 2640, storage devices 2644, application(s) 2646, content filtering system 2624, filters 2626 and delivery system 2620. Such elements are also present within the LPU 2630 but are not identified for clarity.

In the illustrated implementation, a Content Delivery System 2620 is shown which may be stored in device storage 2644 and be executing on the processing unit 2640. The Content Delivery System 2620 monitors the user's biometrics, actions, environment, etc. and creates and maintains an updated model of the current context of the user. As the user moves through different environments, the Content Delivery System 2620 continues to receive the various inputs including explicit user input, sensed user information, sensed user biometrics, and sensed environment information. The Content Delivery System 2620 updates the current model of the user condition, and presents output information to the user via appropriate output devices. The content filtering system 2624 is also stored in memory, storage device(s) 2644 and executing on the processing unit 2640. It utilizes data from the modeled user context (e.g., via the Content Delivery System 2620) to selectively filter information according to the user's current environment in order to determine whether the information is appropriate for presentation. The filtering system 2624 employs one or more filters 2626 to filter the information. The filters 2626 may be pre-constructed and stored for subsequent utilization when conditions warrant their particular use, or alternatively the filtering system 2624 may construct the filters 2626 dynamically as the user's context evolves. In addition, in some embodiments each filter is stored as a distinct data structure with optional associated logic, while in other embodiments filters 2626 can be provided as logic based on the current context, such as one or more interacting rules provided by the filtering system or Content Delivery System 2620.

The LPU 2630 may be body-mounted in some embodiments of the invention or alternatively it may be associated with an item of clothing, a PED associated with the user, a wearable computer worn by the user, or be implanted. The LPU 2630 may be connected to one or more networks through wired or wireless communication technologies, e.g. wireless, near-field communications, cellular network, modem, infrared, physical cable, a docking station, set-top box, etc. For example, a body-mounted computer of a user may access other output devices and interfaces such as a FED, smart television, cable modem, etc. to transmit/receive information rather than being connected continuously. Similarly, intermittent activities such as connecting via a cable or docking mechanism, for example, may trigger different behaviour than to the continuous wireless such as for example firmware upgrades, data backups, archive generation, full biometric downloading, etc. It would be evident that the body-mounted LPU 2630 is merely one example of a suitable client computer. There are many other implementations of client computing devices that may be used to implement the content filtering system. In addition, while the LPU 2630 is illustrated in FIG. 26 as containing certain computing and storage resources and associated input/output (I/O) devices, in other embodiments a LPU 2630 may act as a thin client device that receives some or all of its computing and/or storage capabilities from a remote server. Such a thin client device could consist only of one or more I/O devices coupled with a communications mechanism with which to interact with the remote server.

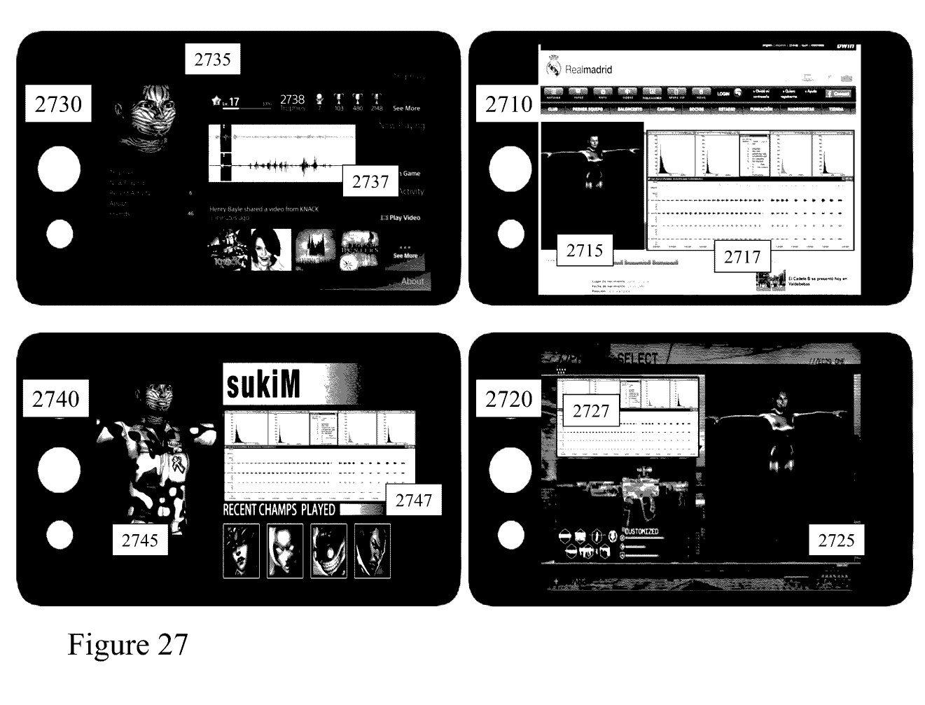

With the capture of image data relating to the user to generate their avatar within the SSSA alternate avatars may be generated within other virtual environments other than the user's SSSA, SOCNETs, SOMEs etc. For example, the user may be embedded into gaming environments based upon the insertion of their personal avatar rather than the display of an avatar within the game. Accordingly, as depicted in FIG. 27 the adaptation of an avatar based interface to online gaming environments according to an embodiment of the invention is depicted by first to fourth display screens 2710 to 2740 respectively. In first display screen 2710 the user's avatar has been “clothed” in a one piece suit determined, for example, by the environment of the game, other player clothing etc. and represented by first avatar 2715. In this instance, perhaps the game is a futuristic one. Also depicted within first display screen 2710 is a first biometric summary 2717 relating to the user to whom first avatar 2715 relates. The user in this instance appears with their body and head as they are naturally are whereas in second and third display screens 2720 and 2730 respectively the user has had their skin tone adjusted through the gaming software to match the characteristics of the character that they are playing. However, as evident in second display screen 2720 their clothing is still the same as is their body with second avatar 2725. Also depicted within second display screen 2720 is a second biometric summary 2727 relating to the user to whom second avatar 2725 relates. Similarly, in third display screen the user's avatar is displayed as third avatar 2735 together with third biometric summary 2737 relating to the user to whom third avatar 2735 relates. Finally in fourth display screen 2740 the user's clothing for their fourth avatar 2745 is now adjusted to a military uniform to reflect the game they are playing whilst their skin tone has been adjusted but their physical profile in terms of face, hair, physical characteristics remains that defined by their baseline avatar as does fourth biometric summary 2747 relating to the user to whom fourth avatar 2745 relates.

Accordingly, a user may insert their avatar into a game, where the game provides for this feature, and may depending upon the features within the software adjust their skin tone, adjust their clothing or have these aspects automatically manipulated by the gaming software. Even where an avatar may not be inserted into the game based upon the real world or virtual world generations described supra the profile for their character may display their biometric summary in a similar manner to those described and depicted in first to fourth display screens 2710 to 2740 respectively. These concepts may be extended such that the characteristics of the character that the user is playing within the game may be adjusted in respect of the user's personal characteristics as defined by their SSSA avatar and profile/biometric data relating to the user. Accordingly, when running within a game the character may be slower/faster according to the characteristics of the user or their stamina may be adjusted or their ability to hold their breath adjusted based upon their respiratory characteristics. Such restrictions may require therefore the user in playing the game to adapt to new strategies, establish new solutions, etc. to the problems presented to them during the game. In other embodiments the complexity of logic puzzles, etc. may be adjusted to the mental characteristics of the user or their skills limited/expanded based upon their real world characteristics.

The determination of what biometric data is presented within first to fourth display screens 2710 to 2740 respectively within first to fourth biometric summaries 2717, 2727, 2737, and 2747 respectively may be established in a variety of ways. Within one embodiment of the invention a biometric graph, e.g. biometric graph 3030 in first screen 3000 in FIG. 3B, or a biometric screen, e.g. enhanced biometric screen 3070 in second screen 3050 in FIG. 3B, is established through the association of the contexts so that, for example, whenever the user is in context such that they would be presented with first screen 3000 in FIG. 3B then the biometric graph 3030 is displayed on their gaming profile and subsequently when the user is in context such that they would be presented with second screen 3050 in FIG. 3B then the biometric graph 3070 is displayed on their gaming profile pages. Alternatively, the user may establish one or more gaming biometric screens through techniques known within the prior art, e.g. drop-down menus, templates, selections, etc. such that these are displayed upon their gaming profile(s) in association with the contexts that the user links to them. A user may establish just one gaming profile biometric screen which is displayed in all contexts. Alternatively, the user may establish multiple gaming profile biometric screens which are displayed in all contexts but at established in dependence upon the association of the user and the individual accessing their gaming profile profile such that, for example, their spouse sees one gaming profile biometric screen, their family another SOME biometric screen, friends a third gaming profile biometric screen, and a fourth gaming profile biometric screen to all other individuals.

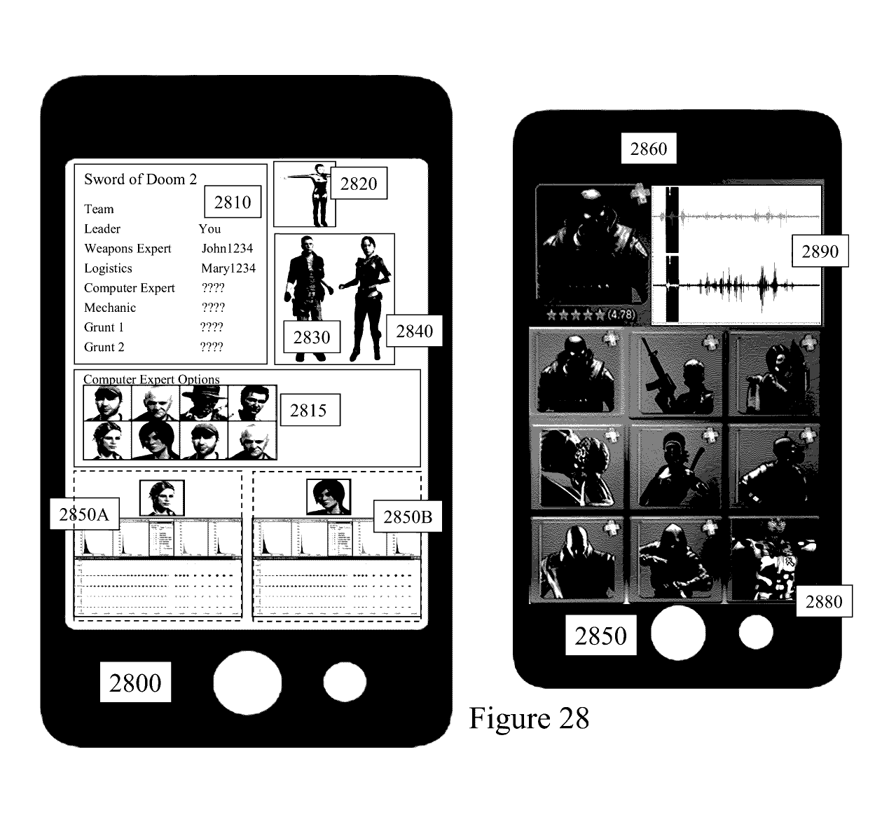

Accordingly, these concepts may be extended into gaming within multiplayer environments such that as described in respect of FIG. 28 in first and second screens 2800 and 2850 a multiplayer gaming team may be established in dependence upon the physical and/or biometric characteristics of the users registered with the game. Accordingly, in first screen 2800 the user is establishing a team for “Sword of Doom 2” as indicated by team composition 2810. The user's gaming avatar is depicted as first image 2820 whilst the team members currently selected are presented as second and third images 2830 and 2840 respectively representing the “Weapons Expert” and “Logistics Expert” respectively. Next the user is selecting a computer expert which results in image wall 2815 being presented with other gaming community members who have profiles/skills aligning with the requirements of the “Computer Expert.” The user may select an image(s) within the image wall 2815 and be presented with a biometric profile(s) based upon the biometric profiles of the users within the gaming community associated with the avatars the user has selected. As such the user is presented with biometric data 2850A and 2850B for the avatars selected from image wall 2815. Accordingly, the gaming user may select one of the avatars based upon the biometric data alone or in combination with the skills, characteristics etc. within the framework of the game. In some embodiments of the invention the biometric characteristics of the avatar are established by the game creator and employed to filter the gaming community to provide the options to the user within the image wall 2815. Optionally, the user may be able to adjust/manage the biometric characteristics of the avatar character as potentially no or a limited number of options are presented. Optionally, the user may establish the biometric characteristics themselves in part or completely through one or more techniques known within the prior art including, but not limited to, drop own menus, selection lists, option tables, etc.

Accordingly, the user may subsequently select the avatar they wish to add and they join the team. Joining the team may be automatic within some embodiments of the invention as the users on the image wall 2815 are those currently not playing within a team or the player is playing single player mode. In other embodiments of the invention the selected user may be invited to join. Accordingly, embodiments of the invention provide for establishing a gaming group based upon biometric profiles of avatars associated with users wherein the avatar characteristics are based upon real world aspects of the users to whom the avatars are associated. Similarly, in second display screen 2880 the user finds their avatar 2880 listed as part of a team selection screen 2860 which includes biometric data 2890.

Biometric Feeds within SOCNETs

Within the descriptions supra a user may form/join SOCNETs and have their SOCNETs adapt to reflect their context and/or biometrics. Additionally, a user may be dynamically presented with a feed about the biometrics of user or group of users of a SOCNET that they are a member of. For example, a user who is a runner may wish to follow Ryan Hall, the American marathon and long distance runner and US 2012 Olympic team member. Accordingly, the user (the viewing user) of a SOCNET may choose to view a biometric feed about another user (the subject user) in the SOCNET wherein a list of the subject user's activities within the SOCNET may be drawn from various databases within the SOCNET. The biometric feed is automatically generated based on the list of activities and may be filtered, for example, according to priority settings of the viewing user and/or privacy setting of the subject user. The list of activities may be displayed as a list of biometric items presented in a preferred order (e.g., chronological, prioritized, alphabetical, etc.). Various biometric items in the biometric feed may include items of media content and/or links to media content illustrating the activities of the subject user. The biometric feed may be continuously updated by adding biometric items about new activities/time periods and/or removing biometric items about previous activities/time periods. Accordingly, the viewing user may be better able to follow the “track” of the subject user's “footprints” through the SOCNET, based on the biometric feed, without requiring the subject user to continuously post new activities.

Accordingly, one or more users with their PED/FED are coupled to a SOCNET via a network wherein the SOCNET, SOCNET networking services, SOCNET communication services, SOCNET dating services, etc. which may include in addition to publically accessible SOCNETs SOCNETs that are not publically available but are limited, for example, to a company, an enterprise, or an organization, allow the user to access a website or other hosted interface allowing the users with the PEDs/FEDs to communicate with one another via the SOCNET. In some embodiments a SOCNET environment may include a segmented community. A segmented community according to one embodiment is a separate, exclusive or semi-exclusive web-based SOCNET wherein each authenticated segmented community member accesses and interacts with other members of their respective segmented community.

In one instance, a viewing user associated with a PED/FED requests a biometric feed (i.e., mini-feed) about a subject user associated with another PED/FED via a SOCNET website associated with the SOCNET provider. Any user, in principle, within the SOCNET may request a mini-feed and become the viewing user or become the subject user as the subject of a mini-feed request. In some embodiments, the viewing user and the subject user may be the same user, for example, for purposes of reviewing a personal mini-feed. A mini-feed engine is coupled to the SOCNET provider which utilizes data about a particular user (e.g., the subject user), to assemble a list of one or more items of biometric data, media content associated with biometric data or any other content for display to a user such as the viewing user associated with or determined in dependence upon the subject user's biometric data. Examples of a subject user may include a user, an association of users (e.g., a family), a group of users, an organization of users (e.g., a sports team), members of an event (e.g., a concert), students in a class (e.g., Grade 11 Mathematics, Thomas Edison High School, San Antonio, Tex.), members of a club (e.g., Miami Dolphins Fan Club), etc. According to some embodiments, the viewing user may be coupled directly via the PED/FED to the mini-feed engine. According to other embodiments, the mini-feed engine comprises a module associated with the SOCNET provider.

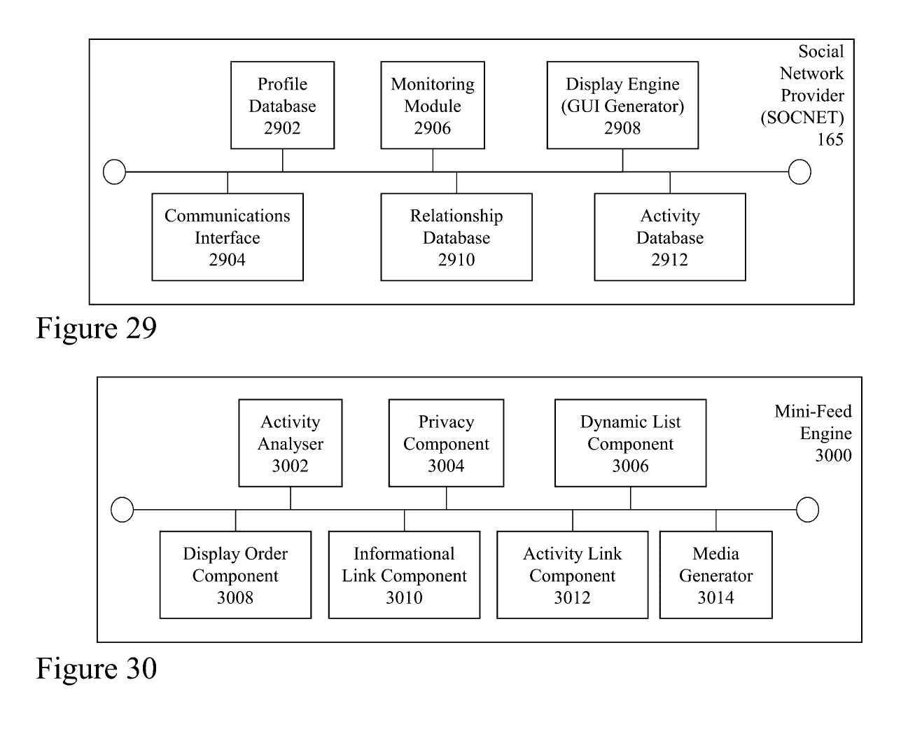

Referring now to FIG. 29, a block diagram of an exemplary SOCNET provider is shown, such as a SOCNET 165 in FIG. 1. A profile database 2902 is provided for storing data associated with each of the users, such as the user associated with PED/FED. When a user subscribes to services provided by the SOCNET, a user profile may be generated for user. For example, the user may select privacy settings, provide contact information, provide personal statistics, specify memberships in various organizations, indicate interests, list affiliations, post class schedules, detail work activities, or group other users according to one or more categories. When the user adds additional information to the user profile, such as adding additional contacts, the user profile in the profile database 2902 may be updated with the information added. The user profile may be stored, modified, added, and so forth to any storage medium. A timestamp may be associated with the user profile. Examples of timestamp include order of occurrence in a data base, date, time of day, etc.

According to some embodiments, the user profile is created outside of the SOCNET environment and provided to or accessed by the SOCNET. Alternatively, the profile database 2902 may be located remotely and accessed by the SOCNET. The SOCNET includes a communications interface 2904 for communicating with users, such as via the PED/FED described herein, over a network, e.g. network 100 in FIG. 1. The PED/FED communicates various types of information, such as privacy settings selections, groupings of other users, and so forth, to the SOCNET via the communications interface 2904. Any type of communications interface 2904 is within the scope of various embodiments. A monitoring module 2906 tracks one or more user activities on the SOCNET website. For example, the monitoring module 2906 can track user interaction with one or more items of media content, such as biometric stories, other users' profiles, email to other users, chat rooms provided via the SOCNET, and so forth. Any type of user activity can be tracked or monitored via the monitoring module 2906. The information, people, groups, stories, and so forth, with which the user interacts, may be represented by one or more objects, according to exemplary embodiments. The monitoring module 2906 may determine an affinity of the user for subjects, other users, relationships, events, organizations, etc. according to users's activities.

A display engine/GUI 2908 may also be provided by the SOCNET. The display engine/GUI 2908 displays the one or more items of media content, profile information, and so forth to users. Users can interact with the SOCNET via the display engine/GUI 2908. For example, users can select privacy settings, access their own user profile, access other users' 101 information available via the SOCNET provider, and so forth, via the display engine/GUI 2908. The mini-feed may be displayed in a field in the display engine/GUI 2908. A relationship database 2910 is provided for storing relationship data about each user. In various embodiments, the viewing user can specify relationships with one or more subject users of the SOCNET via the user profile, or by any other means. The viewing user can assign categories, groups, networks, and so forth to the one or more subject users with which the viewing user has a relationship. The relationship, for example, may specify that the subject user is a family member, a schoolmate, an ex-girlfriend, an esteemed rival, and so forth. Any type of relationship may be specified.

An activity database 2912 is provided for storing activity data about each user. The activities may be tracked by the monitoring module 2906. Activities monitored by the monitoring module 2906 may be stored in the activity database 2912. Activity entries in the activity database 2912 may include a timestamp indicating time and date of the activity, the type of activity, the user initiating the activity, any other users who are objects of the activity, etc. Activities may be stored in multiple databases, including the activity database, the profile database, the relationship database, etc.

According to some embodiments, the SOCNET may determine a relationship for the user. For example, if user establishes communications with another user interested in managing diabetes, the SOCNET may assign the relationship of “Medical” & “Diabetes”. The SOCNET may inquire whether or not user wants to add the other user as a friend, follower, leader, partner, supporter, sponsor, etc. according to the relationship assigned. The SOCNET may utilize a common interest in diabetes as a variable to measure the user affinity, for medical information and/or the other user without inquiring whether user wants to add the other user to their user's profile, according to some embodiments. A relationship may be assigned based on a user's interaction with other users or with any type of content. The user may have more than one relationship with other users or with content, according to exemplary embodiments. For example, a user's partner qualifies as one type of relationship, while the fact that the user's partner is also diabetic as the user may qualify as another relationship. Any number of relationships may be established for each user and/or for each activity performed by the user in the SOCNET environment. A timestamp or other chronological indicia may be associated with entries in the relationship database 2910.

According to exemplary embodiments, one or more networks may be provided for each user. For example, user may have a network comprised of people grouped according to a biometric parameter or parameters (e.g. heart arrhythmia, high blood sugar, etc.), a network comprised of people grouped according to the user's geographical location of residence, a network comprised of people grouped according to a common field of biometric data (e.g. joggers, swimmers, yoga, pilates, high sex drive etc.), a network comprised of people grouped according to a particular biometric aspect (e.g. pulmonary heart disease, weight loss, diabetes, irregular sleep etc.), and so forth. As discussed herein, a common network may establish a relationship between user and other users in the common network, for example. Any type of network may be provided by the SOCNET. In other words, a network may comprise people grouped according to any type of category, such as various SOCNETs described herein, like “fellow sufferers”, “fellow marathon runners”, “geographical location”, and so forth. User may specify the networks, the categories, subcategories, and so forth and/or the networks, the categories, the subcategories, and so on may be predetermined by the SOCNET. The networks, categories, the subcategories, and so forth may comprise a relationship with the user, as discussed herein, but do not necessarily comprise the only relationship user has with the other users.

Although the SOCNET is described as being comprised of various components (the profile database 2902, the communications interface 2904, the monitoring module 2906, the display engine/GUI 2908, and the relationship database 2910), fewer or more components may comprise the SOCNET and still fall within the scope of various embodiments. The mini-feed engine 3000 is configured to receive data about a particular user of a SOCNET, e.g., the subject user, and assemble a list of one or more activities to be displayed as biometric items about of the subject user. The biometric items may be in the form of items of biometric data, media content associated with biometric data, or any other content for display to the viewing user. The mini-feed engine 3000 may filter the activities according to privacy settings of the subject user and/or priority settings of the viewing use. The mini-feed engine 3000 may compile a dynamic list of a limited number of biometric items about the subject user for display in a preferred order. The mini-feed engine 3000 may provide the viewing user with links related to various activities in the biometric items, and other links providing opportunities to participate in the activities.

FIG. 30 depicts a block diagram of an exemplary embodiment of the mini-feed engine 3000. The mini-feed engine 3000 includes an activity analyzer 3002, a privacy component 3004, and a dynamic list component 3006, for determining the activities regarding the subject user that may be displayed as biometric items. The mini-feed engine 3000 further includes a display order component 3008, an informational link component 3010, an active link component 3012 and a media generator 3014, for displaying the biometric items to the viewing user.

The activity analyzer 3002 accesses the one or more user activities detected by the monitoring module 2906 and analyzes the one or more user activities to compile a mini-feed activity list of activities associated with the subject user. Optionally, the activity analyzer 3002 may access the one or more activities from the various data bases (e.g., the profile database 2902, the relationship database 2910, the activity database 2912, a biometric database, etc.). The activities may include activities performed by the subject user, e.g., add an affiliation to a group, terminate an affiliation with a group, add information to the profile, remove information from the profile, hide elements of biometric data, show elements of biometric data, RSVP to an event/request, withdraw an RSVP response/request, activate a mobile data connection, add a note to the notes file, add multimedia content in association with specific biometric data, approve a relationship request, create an event, create a group, share biometric data, create a profile, associate contexts to profile, etc. The activities may include activities performed by other users relating to the subject user (e.g., the subject user is approved by another for a relationship, the subject user is mentioned by another user in their notes, the subject user receives a promotion, the subject user is tagged by another user in their photo album, etc.). The activities may include activities outside the SOCNET, e.g., access an article from Wall Street Journal, book a GP appointment, meet SOCNET users, schedule an activity, etc. Optionally, the subject user's activities may be stored in a user activity storage medium (not shown) associated with the mini-feed engine 3000 and/or the SOCNET.

The privacy component 3004 is configured to analyze the privacy settings of the subject user and filter out activities belonging to categories that the subject user has elected to not display in the mini-feed. For example, activities involving the subject user and the viewing user's wife may be designated as private by the subject user's privacy settings and omitted from the mini-feed activity list displayed to the viewing user. The privacy settings may be variable and prevent one particular user from viewing activities regarding the subject user that another particular user might be permitted to see. For example, the subject user might permit her sister to see activities regarding the subject user and the viewing user's wife. The privacy component 3004 may include default privacy settings. The default privacy settings may be determined by the SOCNET. The dynamic list component 3006 is configured to limit the number of biometric items displayed. In some embodiments the dynamic list component 3006 selects current activities, e.g., the most recent twenty activities according to the timestamp, for display as biometric items. In various embodiments, the dynamic list component 3006 selects activities according to viewing user priorities (e.g., viewing user affinity), viewing user preferences (e.g., viewing user profile settings), subject user priorities (e.g., subject user affinity), subject user preferences (e.g., subject user profile settings), filters, etc. For example, the viewing user may set a filter for the dynamic list component 3006 to show only relationship activities of the subject user in the biometric items display. In another example, the dynamic list component 3006 may display only the ten highest weighted activities of the subject user, according to the affinity calculations for the viewing user. Optionally, the dynamic list may include a predetermined number of entries, e.g., 40 entries, and the biometric items may be selected according to the most recent 40 activities.

In some embodiments, the dynamic list component 3006 may maintain a biometric feed for each user comprising a list of a predetermined number of biometric items (e.g., 40 entries) about the user. The dynamic list component 3006 may place the most recent biometric item at the top of the list and remove the oldest biometric item from the bottom of the list for each new activity. Optionally, the dynamic list component may associate a unique mini-feed profile with each mini-feed for each user. The lowest priority biometric item may be removed according to the mini-feed profile, and a new biometric item may be added to a position on the list according to the relative priority of the new biometric item, according to the mini-feed profile. The display order component 3008 is configured to determine an order for the display of the biometric items. In some embodiments, the list of biometric items may-be sorted according to a timestamp associated with the respective activities. In other embodiments, the list of biometric items may be sorted according to a viewing user priority (e.g., affinity determinations, viewing user preferences, etc.), a subject user priority (e.g., affinity determinations, subject user profile, etc.), alphabetical order of a field within the biometric item display, etc. In some embodiments, multiple field sorts may be applied to the biometric item display. For example, the viewing user may configure his preferences to display relationship activities first followed by event activities second, etc., and to display the relationship activities (and then the event activities) in a chronological order.

The informational link component 3010 is configured to provide the viewing user one or more informational links to an activity of the subject user. The informational links may provide the viewing user additional information about the activity that is the subject of the biometric item. For example, an informational link may connect the viewing user to a web page about a group that the subject user has joined. In various embodiments, an informational link may enable the viewing user to view a photo added to the subject user's photo album, to view information about a class the subject user has enrolled in, etc. The active link component 3012 is configured to provide the viewing user one or more active links to an activity /biometric aspect of the subject user. The active links may enable the viewing user to participate in the activity/activities related to the biometric item or track the user's biometrics in association with their own. For example, an active link may enable the viewing user to join a group that the subject user has joined/hosts. In various embodiments, an active link may enable the viewing user to download content added to the subject user's photo album, to enroll in a class the subject user has enrolled in/runs/manages, to join a club the subject user has joined/runs/manages, and so forth. In some embodiments, the active link and the informational link may enable the viewing user to perform the same function.

The media generator 3014 is configured to format the activity list compiled by the activity analyzer 3002 and display one or more biometric items according to the privacy component 3004, the dynamic list component 3006, and the display order component 3008. The media generator 3014 is further configured to provide functionality to any links attached by the informational link component 3010 and/or the active link component 3012. In some embodiments, the media generator 3014 provides the display of the biometric items to the display engine/GUI 2908 for display to the viewing user. Alternatively, the media generator 3014 displays the biometric items to the viewing user via the PED/FED. In some embodiments, the media generator 3014 may be configured to attach advertising/content to the mini-feed display. Examples of advertising/content include, but are not limited to, a depiction of a product, a depiction of a logo, a display of a trademark, an inducement to buy a product, an inducement to buy a service, an inducement to invest, an offer for sale, a product description, trade promotion, a survey, a political message, an opinion, a public service announcement, an invitation, a request, an offer, educational information, a coupon, entertainment, a file of data, an article, audiovisual content, multimedia content, audio content, visual content, etc. The format of the advertising may include, singularly or in combination, an audio or animation or other multimedia element played at various times, banner advertising, network links, e-mail, images, text messages, video clips, audio clips, programs, applets, cookies, scripts, etc. Although the mini-feed engine 3000 is described as being comprised of various components (e.g., the activity analyzer 3002, the privacy component 3004, the dynamic list component 3006, the display order component 3008, the informational link component 3010, the active link component 3012, and the media generator 3014), fewer or more components may comprise the mini-feed engine 3000 and still fall within the scope of various embodiments.

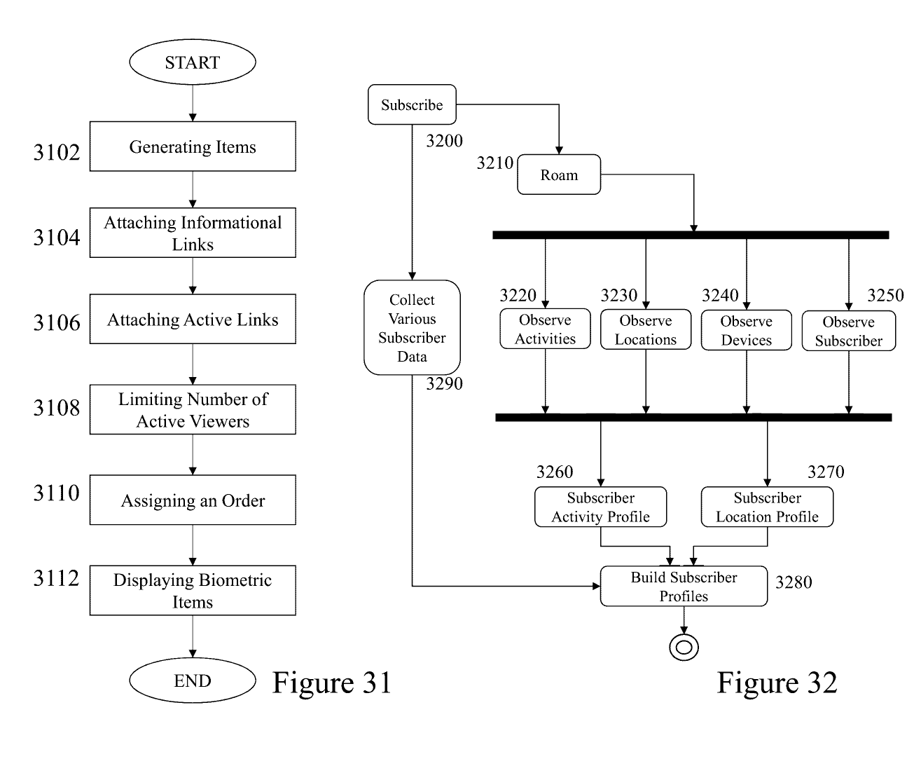

Referring now to FIG. 31 there is depicted a flow diagram of an exemplary process for generating and displaying a biometric feed about activities of a user of a SOCNET is provided. At step 3102, biometric items relating to activities performed by a subject user associated with a SOCNET environment are generated. For example, the activity analyzer 3002 may collect a list of one or more activities associated with the subject user from monitoring module 2906 and optionally from the various databases in the SOCNET (e.g., the profile database 2902, the relationship database 2910, the activity database 2912, etc.). The list of activities may include emails, viewing of user profiles, viewing of users' photos, receiving a promotion, sending messages to other users, and so forth, as discussed herein. The list of activities may be filtered according to preferences set by the viewing user and/or the subject user.

At step 3104, informational links may be attached to one or more biometric items generated in the step 3102. For example, the informational link component 3010 may determine relevant links relating to activities to attach to one or more of the biometric items. As another example, the subject user may begin to cohabitate with her girlfriend and thus the relationship database 2910 may provide a biometric item regarding the establishment of the cohabitation relationship. A link to the subject user's b girlfriend may be attached by the informational link component 3010 to the biometric item at the step 3104, enabling the viewing user to view entries regarding the girlfriend. In some embodiments, the informational link may be a dropdown menu including, for example, the girlfriend's email address, a link to her public profile, and a mini-feed about the girl friend.

At step 3106, an active link may be attached to one or more biometric items generated in the step 3102. For example, the active link component 3012 may attach an active link to the biometric item regarding the establishing the cohabitation relationship (discussed elsewhere) enabling the viewing user to email congratulations to the girlfriend. In some embodiments, the active link may be a dropdown menu providing a selection from a list of actions including, for example, a download link to the girlfriend's photo, an invitation to join the circle of the girlfriend's mutual friends, and a link to join her next Bodacious Beer Bust Binge.

At step 3108, the number of users who may view the mini-feed may be limited. For example, the privacy component 3004 may limit display of the mini-feed to only users of the SOCNET. In various embodiments, the privacy component 3004 may limit display of selected biometric items according to a privacy profile stored in the profile database 2902 for the subject user. Alternatively, the privacy component 3004 may limit the mini-feed display to selected users according to the privacy profile stored in the profile database 2902 for the subject user. In some embodiments, the privacy component may filter the activities available for display according to a privacy profile. The privacy component 3004 may limit display of the mini-feed according to default privacy settings. Other components and/or modules may also limit the display.

At a step 3110, an order is assigned to the biometric items. For example, the display order component 3008 may sort the biometric items according to chronological order at step 3110. In various embodiments, the display order component 3008 may assign the order of the biometric items according to a viewing user priority (e.g., affinity determinations, viewing user preferences, etc.), a subject user priority (e.g., affinity determinations, subject user profile, etc.), alphabetical order of various fields within the biometric item display, etc. In some embodiments, the display order component 3008 may apply multiple field sorts to the biometric item display. For example, the viewing user may configure his preferences to display relationship activities first followed by event activities second, etc., and to display the relationship activities in a chronological order followed by the event activities in chronological order.

At step 3112, the biometric items are displayed to the viewing user. For example, the media generator 3014 may format the activity list compiled in step 3102 and display one or more biometric items according to limits imposed on the scope of the viewers at step 3108, and the display order assigned at step 3110. Displaying the biometric items at step 3112 further includes displaying links attached to the biometric item at step 3104 and/or 3106, and linking the viewing user to those links selected by the viewing user. For example, links attached by the informational link component 3010 and/or the active link component 3012 may also be displayed at step 3112 by the media generator 3014. In some embodiments, advertising may be displayed at step 3112. In various embodiments, the active links and/or passive links may include links to advertising. Optionally, the biometric items may be displayed by the display engine/GUI 2908.

Although the process for generating and displaying a biometric feed is described as being comprised of various steps (e.g., generating biometric items 3102, attaching informational links 3104, attaching active links 3106, limiting the number of viewers 3108, assigning an order 3110, displaying biometric items 3112), fewer or more steps may comprise the process and still fall within the scope of various embodiments.

Biometric Based Profiling: FIG. 32 illustrates an activity diagram for profiling a user. Initially a user subscribes to receive wireless service (step 3200). The user roams (step 3210) with his wireless device and the location of the wireless device is determined in accordance with one of the methods known within the prior art, e.g. wireless network or GPS. Data related to the subscriber's location and time at that location, such as time of day, day of week, etc. are stored in a subscriber database in conjunction with the biometric data of the user at that point in time and processed. When processing the data, a subscriber profiler application observes activities that the user partakes in (step 3220), observes locations that the user visits (step 3230), observes the wireless devices (PEDs) that the user uses (step 3240), and observes which subscriber (if the subscriber is actually a household of different users) is using the device (step 3250).

The observed activities (step 3220) are categorized by analyzing the time data, frequency, route, etc. associated with the user. For example, if Monday through Friday mornings between approximately 8:00 AM and 9:00 AM the subscriber takes roughly the same path between Doylestown, Pa. and Philadelphia, Pa., an analogy can be made that the user is commuting to work. Another example, may be that if on Saturday mornings the subscriber goes to numerous locations within town, an analogy can be made that the user is running errands. As one of ordinary skill in the art would recognize, there are rules that could be applied that could classify the type of activities that a user was performing. The classification may be in the form of a probability. That is, depending on the time, the location and other features, a determination might be made as to what the activity the user is partaking in. The user's biometric data over the same time periods is also processed to establish user biometric data to associate with each instance of the activity. The observed locations (step 3230) are based on particular locations that the user visits. The observed locations may be defined by the days of the week, or the times of day that the location is visited within an embodiment of the invention. Within another embodiment the observed locations are defined by the activity. For example, the user visits the store 7-11 on Mondays between 7:30 and 8:00. Additionally, the observed locations may be defined in terms of time spent at the location. For example, in the last week the user was at the park for 3 hours.

The observed devices (step 3240) are generated based on the wireless device (or devices) that the user uses. As previously discussed there are numerous types of wireless devices that include but are not limited to wireless phones, PDAs, and Internet enabled vehicles. The user may always only use one wireless device or the user may use different wireless devices based on the day, the time, the activity, or the location. For example, if the user is traveling for work they may be traveling in an Internet enabled car, have their PDA, and wireless phone. However, if the user is spending time with the family they may only have the wireless phone. Determining when the user uses each device or combination of devices may be useful in determining an activity of the user, developing a predicted route of the user, developing a profile of the user, developing an association of sub-profiles to a profile based upon biometric data etc. The observed activities (3220), locations (3230), devices (3240), and subscribers (3250) can be used to develop profiles of the subscriber in conjunction with the biometric data acquired. The profiles include an activity/routing profile (3260), a location profile (3270), and a subscriber profile (3280). The profiles may be generated based simply on the observed data (e.g. location and biometric) or may be based on the observed data and characteristics associated with the observed data.

An activity/biometric profile 3260 may be generated based solely on the observed activities (3220), and simply predict the activity (or biometric) of a user at a particular time. For example, the activity/biometric profile (3260) may predict that on Monday morning the user is going to commute to work. Another example may be that on Tuesday nights on the way home from work, the user will stop at the grocery store. According to one embodiment, the activity/biometric profile may be generated based on some combination of the observed data (activities, location, device, and subscriber). However, an exception may occur in the activity/biometric profile would place the user going to work on a Monday with biometrics within particular bounds but today the user's biometrics are indicated stress, elevated heart rate, and fast breathing.

The activity/biometric profile and its exceptions may be used to provide profile based data (e.g. traffic reports) to the user. Accordingly, the activity/biometric profile may be deterministic (i.e. Monday morning, activity is commuting, route is Interstate 95) or it may be probabilistic (i.e. Monday morning, activity is 80% chance of commuting and 20% of entertainment, route is 70% Interstate 95, 20% Interstate 83 and 10% other). The activity/biometric profile also knows that whilst Interstate 95 is generally a shorter travel time the user's biometrics are typically indicating prolonged concentration, elevated blood pressure, and elevated heart rate at the end of the drive relative to the beginning. In contrast Interstate 83 is longer both distance and travel time but the user's biometrics are essentially unchanged and/or improved. Accordingly, the user's in-vehicle navigation may be programmed to take Interstate 83. Both the biometric portion and the activity portion of the activity/biometric profile can be updated based on the actions of the user (i.e., as they roam).

Biometrics Automation: Within this description embodiments of the invention are described as being directed to an automation control system for controlling the use of automated devices, such as televisions, heating and air conditioning equipment, lights, window shades or curtains, pool heaters and filtration systems, lawn sprinklers, ornamental fountains, audio/visual equipment, fireplaces, and the like. The automation control system interfaces to a user's PED to acquire biometric data or in other embodiments of the invention interfaces directly to wearable devices, sensors, implanted devices, surgically insert devices, etc. in order to acquire the biometric data. Biometric data relating to the user's physiological and/or neurological status may within some embodiments of the invention be combined with physical biometric data such as may be acquired, for example, through a palm, thumb or finger print scanner, a retinal scanner, face recognition scanner, voice recognition protocol, etc. However, it would be evident to one skilled in the art that the embodiments of the invention described below may be extended to include other contexts including, but not limited to, in vehicle automation, work automation, office automation, and factory automation.

A control system can also include an automation controller or receiver that can be in networked communication with the automation devices and the device(s) providing the biometric data. The automation controller may, in some embodiments, verify the biometric data to grant control within to part or all of the automation network. The automation controller can also enable partial or full access to the automation devices based on the biometric login from the scanner. For example, the automation controller can enable partial access to a television or television stations when a child or guest is associated with the system or allow full access to the television and all the television stations when an adult or system administrator is associated. In this way, the automation control system can provide security access to previously unsecured automation devices.

A control system, in accordance with an embodiment for allowing access to the use of automation devices may include at least one automation device which may, for example, be selected from the group comprising a television, an Internet enabled television, a multimedia recorder, a digital multimedia and/or audiovisual storage device, a gaming console, a light, a thermostat, a garage door opener, a computer, audiovisual equipment, entertainment equipment, a hot tub, a fireplace, an oven, a cooking range, a microwave, a clock radio, an alarm system, an electronic door lock device, heating and air conditioning equipment, window shades or curtains, pool heaters and filtration systems, lawn sprinkler controls, and ornamental fountains.

The control system can also include a biometric scanner. The biometric scanner can scan a user for biological identification information. The biometric scanner can be a thumb print scanner, a finger print scanner, a palm scanner, a retinal scanner, a face recognition scanner, a voice recognition scanner, a visual recognition device, etc. The biometric scanner can gather biometric data from a user to identify the user to the control system. The biometric scanner can be embedded into a touch control panel, a remote control, a key fob, a mini-touch screen, a keyboard, a keypad, a switch, a dimmer switch, an alarm control, a thermostat, etc. In this way, the biometric scanner can be placed in a convenient and inconspicuous location to enhance the usability and security of the control system.

The control system can also include an automation controller. The automation controller can be a programmable receiver or other electronic device, for controlling an automation network. The automation controller can be in networked communication with the automation devices, with the biometric scanner, with the user(s) PED(s) and/or user(s) biometric data generator(s). The communication network between the automation controller and the automation devices can be accomplished through wired, optical, or wireless means. The communication means can include any communication between the media controller and the electronic devices using RF wireless communication such as a standardized communication format under a standardized or proprietary wireless communication scheme. For example, connections between the devices may be wireless connections having a predetermined bandwidth, coaxial connections, wired connections, optical connections, and connections of a specified format such as USB, IEEE 1394, 802.11, Zigbee, HDMI, DVI, component connections, and the like. Communication means can further include optical communication such as infrared or fiber optic communication, or wired communication through a wired connection such as a serial RS 232, USB, Firewire, or some other type of connection configured to transmit information between the media controller and the media wall electronic devices.

The automation controller can also receive biometric data from the biometric scanner. The automation controller can process the biometric data from the biometric scanner to enable access to the automation devices by comparing or verifying the received biometric data with known biometric data stored in resident memory or database of the automation controller.

The automation controller can also receive biometric data from the user(s) PED(s) and/or biometric sensor(s). The automation controller can process the biometric data from the user(s) PED(s) and/or biometric sensor(s) to enable access to the automation devices by comparing or verifying the received biometric data with known biometric data stored in resident memory or database of the automation controller. The automation controller can process the biometric data from the user(s) PED(s) and/or biometric sensor(s) to enable a decision or decisions to made with respect to the automation devices by comparing or verifying the received biometric data with known biometric data stored in resident memory or database of the automation controller.

The control system can also include a database of biometric data. The database can include biometric data from a group of known users of the control system. The database can be accessible by the automation controller. For example, the database can be stored in resident memory of the automation controller. Thus, the automation controller can receive biometric data from the biometric scanner, PED, biometric sensors and can verify the biometric data with the biometric database to identify the user attempting to access the automation device or control system and/or determined what action the automation device or control system should perform. In this way, the automation controller can enable a predetermined level of access/control to the automation devices based on the biometric login verification and/or biometric data. Additionally, the automation controller can restrict access to the automation devices in the case of an unknown biometric data or anomalous biometric data.

The automation controller can also include a security protocol. The security protocol can restrict access to the automation devices networked to the automation controller. For example, the automation controller can receive biometric data and can verify the biometric data with the biometric database to identify the user attempting to access the automation device or control system through the biometric data. If the user is a known user that is verifiable with the database then the automation controller can enable an access level to the automation devices networked to the automation controller. The access level can allow partial or complete access to one or more of the devices networked to the automation controller. In other embodiments the control is open to any user within the home and/or user having a PED/wearable device/sensor which has been associated with the automation controller.

In this way, the automation controller can be used to limit the access of some approved users. Thus, if a child provides the biometric data, the automation controller can verify that the biometric data belongs to a child and can enable only partial access to selected automation devices, such as a television. Accordingly, the automation controller can control the time of the day the television is available to the child user, as well as the television stations available to the child user. On the other hand, if the user is not a known user and the biometric data cannot be verified, the automation controller can lock the control system to completely restrict use of the automation devices. Additionally, if the user is not a known user, the automation controller can allow limited access to the automation devices as a guest user.

It will be appreciated that the automation controller can control the lengths of time as well as the times of the day that automation devices controlled by the automation controller are available for use to particular users. Thus, the automation controller can allow a parent to limit the time of the day a child can access a television or video game system as well as the total amount of time the child can access such devices. Thus, it is a particular advantage of the present invention that the automation controller can enable only partial access of the automation devices to the user. In this way, a multi-level access system can be established with a top level authorization having access to all the automation devices and lower levels of authorization with only partial or limited access to the automation devices.

Automation devices may have electronic security protocols, such as password protections, in order to restrict access to the settings and faceplate controls of the networked automation devices. Furthermore, the automation controller can provide additional security access to the automation devices networked to the automation controller by controlling the power supply in the automation devices or the power supplied from an AC main at the locations of the automation devices. The automation controller can also include an interface for allowing a user to input and access data. The interface can be a keyboard, a touch screen, a remote control, a USB port, an RS 232 port, a serial port, a parallel port, a wireless transmitter/receiver, Internet, etc. The interface can allow the user to program the automation controller in order to customize the settings of the networked automation devices so that upon activation by the automation controller the automation devices can adjust to a preprogrammed state or setting. In this way, the automation controller can be used to “set a scene” in a home based upon a user's biometric data and/or context. Alternatively, the biometric data can be used to override settings associated with a “scene.”

In use the automation controller can receive biometric data from the user's PED and can verify the biometric data with the biometric database to identify the user attempting to access the automation devices or control system through the biometric scanner. Upon verification, the automation controller can access a program associated with the particular user that has biometrically logged in to the system, and can adjust the automation devices to preprogrammed settings preferred by the user. Optionally, multiple preprogrammed settings can be established associated with user biometrics either under user setting or through fuzzy logic based learning algorithms that establish patterns of user biometric data and control settings. The automation controller can communicate with the automation etc. and the biometric scanner through communication devices. The communication devices can be wired communication devices such a Ethernet, USB port, RS 232 port, serial port, parallel port, coaxial cable, cable, data cable, optical cable, a wireless mesh network, or combinations thereof. Additionally, the communication devices can be wireless communication device such as an RF transmitter/receiver, or infrared transmitter/receiver.

Accordingly, the automation controller can determine a person's biometrics for controllably adjusting operations of devices based on those biometrics in an automatic manner. The automation may be from self-learning algorithms that adjust with biometric data and user feedback. Accordingly, examples of home automation through biometric data include, but are not limited to, adjusting environmental controls to reflect user's biometric indications, adjusting audiovisual and/or multimedia playback brightness, sound, colour balance, etc. based upon user's biometrics. Optionally, the automation control may limit a vehicles maximum detecting anger by the user, restrict motion where the user is determined to be impaired through alcohol and/or drugs and/or drowsiness. The automation controller may adjust the thermostat or turn-on a heater, furnace, discrete heater, air conditioner, etc. based upon biometrically determined user body temperature. Lights may be dimmed. Clothing with embedded wearable devices powered down upon detecting user dosing, sleeping for example.

Thus, those skilled in the art will appreciate that computer systems are merely illustrative and are not intended to limit the scope of the present invention. Such computer systems may be connected to other devices that are not illustrated, including through one or more networks such as the Internet or via the World Wide Web (WWW). In addition, the functionality provided by the illustrated components may in some embodiments be combined in fewer components or distributed in additional components. Similarly, in some embodiments the functionality of some of the illustrated components may not be provided and/or other additional functionality may be available.

Further, whilst filters and software components, for example, are illustrated as being stored in memory while being used, these items or portions of them can be transferred between memory and other storage devices for purposes of memory management and data integrity. Similarly, items illustrated as being present on storage while being used can instead be present in memory and transferred between storage and memory. Alternately, in other embodiments some or all of the software modules may execute in memory on another device. Some or all of the described components or data structures may also be stored (e.g., as instructions or structured data) on a computer-readable medium (e.g., a hard disk, a memory, a network, or a portable article to be read by an appropriate drive), and can be transmitted as generated data signals (e.g., as part of a carrier wave) on a variety of computer-readable transmission mediums (e.g., wireless-based and wired/cable-based mediums). In addition, a “client” or “server” computing device may comprise any combination of hardware or software that can interact, including computers, network devices, internet appliances, PDAs, wireless phones, pagers, electronic organizers, television-based systems and various other consumer products that include inter-communication capabilities. Accordingly, the present invention may be practiced with other computer system configurations.

Accordingly, it would be evident to one skilled in the art that the embodiments of the invention with respect to avatar based user interfaces and avatar representations within other software applications, online environments, SOCNETs, SOMEs, etc. provide enhancements of the existing technical solutions and the employed of avatars today. Such enhancements include, but are not limited to,

Humanoid Representation of Biometrics/Characteristics in the form of a Digital Avatar: Today biometric feedback is solely provided to users through dashboards, graphs, charts and the like. At present none of these provide a complete view of the biometrics of a user in association with an avatar profile. Whilst today an avatar may be associated with a user within social and/or gaming settings the behaviour, characteristics, etc. of the avatar are determined by the programming of the social and/or gaming application within which they are implemented. According, to embodiments of the invention, however, the avatar reflects the individual in terms of context, biometrics, profile, etc. Accordingly, an avatar may be limited to skills, characteristics, knowledge, performance, etc. of the individual to whom the avatar is bound. Accordingly, if the user is ill and their physical capabilities reduced then the avatar reflects these either visually to other users or through the avatar's characteristics/performance.

Avatar Feedback: Advantageously according to embodiments of the invention aspects and characteristics of the avatar and hence the user associated are projected/presented directly to the user from the avatar as a central interface for the user rather than through a plurality of disparate and discrete applications as present within the prior art. Accordingly, the user is presented with biometric information in a context that they relate to, themselves. Accordingly, the user can be presented with expanded data in the form of dashboards, icons, badges, graphs, matrix, tables, and the like to represent the data but an overall picture of the user can be presented to them as their avatar in varying representations. The avatar is the first to take this data and create a humanoid representation of oneself with that data. Further, the biometric data may be combined with an avatar based upon the user so that the projections and representations are realistic although if the user elects to then they can view these as fanciful, fantastical, science fiction, etc. based avatars rather than their humanoid avatar. The humanoid characteristic allows the user to attach a true identity to the data as the avatar becomes the digital manifestation of the user through the biometric data that is acquired, processed, and employed in displaying the avatar and associated data to the user. The avatar also allows a user to have a separate social profile with its own biometric data and with the ability of it being autonomous, adaptive, and contextually driven. It allows therefore other users to create connections with the humanoid avatars that more accurately reflect the individuals and who they are.

Avatar Human Biometric Representation: As noted humanoid representations for the avatar allow users to easily acquire all human related functions on one SSSA in a simple visual format. This visual data representation allows users to quickly and accurately see and understand their current states without requiring them to access multiple dashboards, graphs, data tables, etc. However, the user can access these additional detailed aspects of their current, historical and future self through interaction with the avatar. A user can through the acquisition of different sensors, wearable devices, software, applications, etc. expanded specific or general aspects of their avatar to display their biometrics, skills, characteristics, etc. These can include, but are not limited to, the following aspects skills, health, intelligence, social media, gaming, emotions, states of mind, motivation, food, and pictures/videos.

Biometric Anonymity: According to embodiments of the invention a user has the option of binding tying in their true identity and real life pictures of themselves to their avatars or creating an identical digital image. Users also have the option of being completely anonymous and releasing only portions of their biometrics to the world through an avatar whose characteristics, behaviour, mental state, etc. are mirrors of the user but has a physical representation that is not linked to their real world image. In this manner a user can engage in online communities, games, etc. as themselves in that their avatar behaves as they do but with a different identity. Embodiments of the invention may limit the deviations of the alter-self from the real world self such that, for example, age, gender, etc. are bounded by the user's real age, gender, etc.

Evolving Avatar: As evident from the preceding descriptions in respect of FIGS. 1 to 15 a user's avatar evolves to reflect their real world profile and/or their biometric profiles/feedback. As a user's body changes then so does their avatar as presented to themselves and to third parties including, for example, the attributes and characteristics of gaming avatars for example. Accordingly, games and gaming communities may evolve to reflect the real world wherein goals are achieved through teams with different skills, with groups that collaborate and build from each other. No longer is the winner the strongest, fastest, most aggressive character.

Within embodiments of the invention the user may be required to ensure that their avatar evolves alongside them through biometric acquisition, image addition, skill updates etc. For example, if a user does not synchronize data to their avatar the avatar slowly dies and the user is prompted to synchronize more data. If the user has a qualification or attribute requiring periodic renewal, authorization, etc. then the attribute, gear, icons, etc. of their avatar adapt if this requalification/authorization does not occur. According to embodiments of the invention therefore evolve and grow with the user whilst retaining their history or facilitating positive reinforcement/intervention.

Avatar Views: An avatar may have multiple views with the same biometrics and user profile for example. Such avatar views may for example be “re-skinning” to reflect context, environment, etc. Others may be adjusting the avatar to reflect different cross-sections/systems within the human body, e.g. displaying respiratory, pulmonary, heart, brain, muscle, etc. with coding to reflect status, issues, changes, etc. Avatars may be displayed with skins to reflect standardized views although their facial and physical characteristics reflect the base characteristics of the user. For example, a medical nurse may be displayed with standard skinned uniform or the gear associated with a lawyer may reflect their profession.

Visual Biometric Feedback from Avatar: Evolving sensor technologies can already determine aspects of the user such as blood glucose, blood oxygenation, respiration rate, steps made, stairs climbed, and approximate others such as calorific intake or derive these from other data provided by the user. For example, identifying a meal may result in extraction of nutritional data from remote database. Increasingly, the capabilities of existing sensor will expand and others will be added through technology improvements, cost reductions etc. Through a centralized SSSA such as provided by the avatars according to embodiments of the invention sensor data integration will allow enhanced biometric characterisation, assessment, prediction, and potentially diagnosis. Ailments, deficiencies, etc. may be detected and/or predicted both holistically for the user and locally within the body of the user. For example, it may be that the user catches a flu bug and sensor technologies detect early indications such as white cell count, elevated temperature, etc. and indicate this to the user visually although in other embodiments of the invention reminders, warnings, alarms, changes, etc. may also be communicated to the user through other systems of the electronic device the SSSA is in execution upon, e.g. an audible message, a voicemail, a text, may be provided to It would be evident that the avatar may be able to represent this data in one of the avatar views as well as to external third parties. For example, biometric data being visualized/presented to the user may be concurrently stored within a secure remote healthcare record of the user. Accordingly, enhanced biometric data may lead to enhanced treatment, increased specificity of diagnosis, earlier diagnosis, etc. Applications in execution upon remote healthcare systems may employ different and/or additional processing algorithms to the biometric data as well as providing updated demographic data/projections etc. to the SSSA for use in displaying data to the user.

Gaming Aspect—Gear: Within the prior art gaming software allows users to acquire rewards/benefits that are unlocked and typically displayed in the form of trophies, badges and icons. Embodiments of the invention allow users to unlock more personal items that complement their avatar or reflect adjustments in the user themselves. Such acquired elements are commonly referred to as “gear.” In the following paragraphs sections relating to displaying, acquiring, social proof, challenges, and classifying embodiments of the invention with respect to gear are presented. This list is non-exhaustive.

Displaying Gear: Prior art gaming and social technologies use gear as a reward mechanism but one that is triggered irrespective of the player within the game as they are simply linked to objectives within the game. In contrast, gear within gaming environments exploiting adaptive evolving avatars according to embodiments of the invention may be adapted based upon the profile of the user's avatar and/or the user's biometrics. Accordingly acquiring a new item of gear to one player may be an increase in energy whereas to another it may be an increase in knowledge. Alternatively, a new item of gear may be acquired by a gamer bringing their blood glucose level down to an acceptable level or equally an item of gear may be lost if they play too long and do not hydrate, eat etc.

Gear: Within prior art gaming platforms gear is depicted as discrete elements acquired by the player and may be viewed similarly by other gamers according to the characteristics of the game. In contrast due to evolving adaptive avatars adding/removing gear is visible to other players as their avatar changes to reflect this. Similarly, an avatars health/ability may be dynamically shown to other users. An avatar associated with a gaming character with injuries may act differently within the gaming environment as it may also due to the biometric data and mental state data of the user.

Acquiring Gear: The gear relating to an avatar may be acquired and/or reduced as the avatars advance through a gaming environment or achieve/miss specific goals. For example, the game may establish goals that are set based upon biometric data or changes in biometric data or other goal achievements relative to biometric advancement. As the user achieves goals with increased difficulty then they may access additional gear. However, the goal may be different for different players based upon their biometrics. Hence, a user with high blood pressure may be set a goal within the gaming environment relating to their blood pressure whilst another may be challenged to reduce the time taken for a 3 km jogging route. In some embodiments the more difficult or the more the user exceeds the goal the rarer the gear the user unlocks. Over time the user can generate a substantial amount of gear that represents key achievements in the real world through accomplishments in their biometrics. Accordingly, the gear for their gaming avatar has a story attached to it that reflects the journey of the user themselves in respect of what they achieved to unlock, maintain, or lose that gear.

Social Proof As a user's gear may be driven by biometric achievements and viewable by other players in a visual and easy to understand way the rapid progression of a gamer through a game by their learning or acquiring cheats/shortcuts etc. is thwarted. When engaging in the avatar social world/community associated with a user's avatar others can then browse the person's gear and learn the personal story behind unlocking or removing that gear etc. Hence, in a game a user may see their gear together with biometric, psychological, physiological goals and/or targets etc. they acquired/adjusted/met in order to unlock that gear. They can also, according to other embodiments of the invention, hover a cursor or other indicator over another avatars gear to highlight and item or access a list of all that player's gear together with viewing the stories behind each or the associated objectives/goals.

Challenges: A user' avatar can be challenged with a real world challenge that may only be achieved through adjustment in their biometric feedback data or acquisition of data from sensors/wearable devices. A challenge may require one or two parties to bet their gear and the winner may or may not take this gear as part of winning the challenge. An example would be if you challenged another avatar to a run and you wanted to acquire an item of gear that took that the avatar 20 km to unlock. If you win the run you have the right to take that gear and add it to you competition gear.

Classifying Gear: Gear can be classified in different categories depending on how it is acquired. When browsing a profile you will be able to see the class of gears and how it was acquired whether through internal, friendly or competitive challenges. Gear is a representation of success in biometric evolution. Accordingly, they may be considered a status symbol with the game or gaming series as they require more than finger skills on a gaming console to achieve.

Social Media & Sharing Biometrics: At present social media solutions to not incorporate biometrics nor do games incorporate a social media aspect on their platforms. Through evolving adaptive avatars and biometric based gear the level of sharing within the gaming environment is increased and leveraged further through the group/team based gaming concepts with skills and characteristics in the virtual online world reflecting those within the real world. Accordingly, achieving objectives within games becomes a means for users to share as well as allowing their online social media to reflect events and activities within the gaming/real world environments such that highlights, successes, etc. are shared together with images and other media rich content within their social feeds and in private messages.

Follow: Athletes, celebrities and other successful individuals or groups may allow their biometrics or portions of their biometrics to be public domain to incentivize or challenge others. Users may wish to follow a regimen of an athlete and may follow them. Within embodiments of the invention access to such biometric data through the SSSA may require the user to register an account and subscribe. Essentially, rather than following an RSS feed or blog they follow the biometrics of an individual by accessing the avatar within the SSSA or another discrete application. Similarly, parents can follow their children, siblings can follow each other, or children can follow and in essence monitor elderly parents or relative. These biometrics can therefore be viewed as the other user's avatar according to the rights/permissions etc. granted by the other user to the follower. This allows individuals who are trying to emulate success a significantly better understanding of how an individual achieves a certain result by tracing their biometrics as well as perhaps nutritional information.

Avatar Groups or Communities: Avatars may be grouped so that they can be followed together. As such trainers, doctors, military personnel, patriarchs, matriarchs and any other individuals with an interest in the biometrics of a group may monitor the group. In some embodiments of the invention a user may become associated with a group and their biometrics may be reported to them during activities, periodically, or continuously together with data for selected individuals within the group, the group as a whole, or as a processed result for the group such that for example the average biometrics of the group are reported. Accordingly, a runner as part of a weekly running club may track their performance, biometrics, etc. against the average of the group or have their biometrics reported absolutely and relative to the distribution of the group biometrics.

Respect: An avatar associated with an individual can be respected by other avatars and the avatars respect may be shown as a numerical data point. It can be shown as a sign of success and respect can be associated with either an avatar discretely or in association with content and/or biometrics associated with the avatar. The respect icon and numerical reference may be shown on the avatars home profile or as part of the avatar skin.

Biometric Based Login: Within other embodiments of the invention biometric data may be exploited to validate a login process wherein this biometric data is the physiological and/or neurological biometric data which is employed discretely or in combination with other physical biometric data, e.g. fingerprint, and/or security credentials including, but not limited to, password, security credential, challenge response, and security code. In some embodiments of the invention the initial association of a user's physiological and/or neurological biometric data may be made based upon authenticating the user through a known securely issued credential, e.g. a government issued document, government issued identity card, enterprise issued security card, bank issued financial card, etc. Accordingly, the user's biometric data is associated with their access to a physical object, software application, web application etc. wherein the current biometric data relating to the user is compared with stored biometric data by the provider of the software application, web application, etc. or controller of access to the physical object.

For example, a user's gait may be monitored and their access controlled in dependence upon the match of their current gait to the stored gait. Within another embodiment of the application a user's heartbeat may be employed in conjunction with a credential or credentials to provide the required authorization. Accordingly, based upon a training process the user's electrocardiogram (ECG) is analysed for characteristics relating to the PQRST pattern to map their heartbeat which is affected by such things as the heart's size, its shape and its position in the body. Accordingly, the user's biometrics may be employed as part of a direct login process or they may be employed to unlock security credentials that are then employed in a login process such as for example using encrypted public key—private key encryption/decryption elements. For example, a biometric element associated with a user, e.g. their heartbeat, may be characterised, encrypted and form part of a hashing process with a security key. Subsequently, the hashed key is stored, for example, upon a system and may only be decrypted through a reverse hashing process with the user's heartbeat and/or other biometric data employed in generating the original encrypted key.

Within some embodiments of the invention a user may be restricted from a login process based upon their biometric data. For example, a determination that a user is depressed may restrict the user purchasing medications, alcohol etc. Similarly, a determination that a user has reached a predetermined blood alcohol or breath alcohol level may prevent the user from purchasing further alcohol with a financial instrument, smart wallet etc. or alert staff within a bar, for example, that the user should not be served further. In other instances, combinations of biometric data relating to physiological and/or neurological may limit the features/attributes of a software application to a user. For example, an angry user may be prevented from sending electronic messages (e.g. email, text, blog, post, etc.) or using their telephone.

Optionally, the login credential of a user may be, for example, be a combination of physical biometric data with physiological and/or neurological data such that, for example, the credential may be the hashing of data based upon the redaction/extraction of an image of the user acquired from camera, photographic identity document, etc. with their heartbeat, for example. Accordingly, the user may subsequently generate in realtime their credential based upon their image being acquired at a terminal, kiosk, etc. and their heartbeat being provided from their smartphone that is acquiring this data. Optionally, the transaction may be disabled in the event that their heartbeat is outside a predetermined range, i.e. it is racing which may be indicative of stress such as coercion.

Changing Environment based upon Biometric Feedback: Within other embodiments of the invention the environment presented to a user within the real world and/or a virtual world may be adjusted in dependence upon their biometric data and/or information derived from their biometric data. Accordingly, biometric data indicating that the user is dosing, sleeping, lacking concentration, etc. may result in the user's electronic device, e.g. PED/FED, making a decision. The decision may include, but not limited to, to logging the user out of the online services they were logged into, closing applications in execution (e.g. word processing, browser), adjusting the volume of multimedia content being presented to the user (e.g. turn down the volume on iTunes, adjust the volume on their television, etc.), and pausing playback of audiovisual content.

Biometric Data to Form/Join SOCNETs: Based upon the accumulation of data relating to users according to embodiments of the invention and the user's registration with a SOCNET/SOME as described supra a user may be provided with one or more features in respect of the SOCNET/SOME or multiple SOCNETs/SOMEs. Accordingly, the more biometric data that a user shares with the SOCNET/SOME the more features that the user has access to within the SOCNET/SOME or other software application/system. For example, a basic registration may have the user sharing heart rate and breathing rate as part of their profile together with or without the contextual variations of the user's avatar to reflect their current context and/or the SOCNET/SOME/software application/system. However, if the user elects to share, for example, their blood glucose levels with the SOCNET/SOME then the user may be provided, for example, with enhanced filtering options for posts made by others within the SOCNET/SOME or some other added feature. This biometric data may be provided, for example, upon the user agreeing to terms and conditions that the data may be used by third parties but will be employed in an anonymous format such the user cannot be identified by the third party. In an alternate embodiment of the invention, the user may agree to different terms and conditions that they may be identified to a third party who may subsequently contact the user. Accordingly, third party may acquire a large dataset of blood glucose data from users allowing them to exploit this within marketing, product development, research and development, etc. In instances where the user's biometric data is particularly important then the third party may contact the user to seek additional biometric, physiological, neurological, socioeconomic data etc. for their requirements and offer an incentive or incentives specific to this instance. Accordingly, for example, whilst the third party may segment and analyse their data by demographic data etc. they may find statistically identify a particular issue with temporal-spatial characteristics that they wish to explore. For example, why do all women in Northern California aged 35-65 years old experience a significant blood glucose level drop between 9 am and 11 am.

Within another embodiment of the invention the user may share biometric data with a SOCNET/SOME which processes, analyses, filters the data to identify particular characteristics of the user which are then used to prompt the user with respect to other users, social communities, SOCNET/SOME members, SOCNET/SOME enterprises, etc. that are related to the particular haracteristic of the user. For example, the blood glucose level of the user may trigger the SOCNET/SOME to suggest that the user accesses content relating dietary adjustments, medical treatments, etc. according to the analysis of the user's biometric data. Alternatively, the SOCNET/SOME may provide a suggestion in respect of the user joining a social group/association/network associated with managing diabetes for example. Subsequently, the user may be automatically joined based upon their request and biometric data.

Optionally, the user may prompted with respect to other users within the SOCNET/SOME having similar biometric data elements together with their social profile information. Accordingly, the user may be, for example, a 55 year woman living in Pasadena, Calif. and be advised that there are 155 women in the same area within the age range 52-57 having diabetes of whom 15 have formed a self-help group and accordingly the user may be linked to a social group, community, association that they would otherwise not be aware of that due to its characteristics, e.g. similar demographic, local, self-help, etc., may provide a forum for them to learn, exchange, provide, knowledge etc. that allows them to actively manage and adjust their diabetes potentially faster with longer term success than their joining an essentially anonymous third party. However, in other instances these anonymous third parties may be presented or have higher priority to the user due to characteristics of the user and/or their biometric data. Similarly, associations that have not been established may be upon analysis of the biometric data. For example, a user who registers and is determined as having chronic levels exceeding 7 mmol/l (125 mg/dl) may be advised to visit their general practitioner (GP). Similarly, a user who has been part of a SOCNET/SOME community in respect of diabetes but has suddenly shown consistently higher than normal biometric data may be recommended to contact their GP. Within another embodiment of the invention the SOCNET/SOME dependent upon analysis may trigger actions such as the contacting of paramedics, for example.

Biometric Fencing

Within the description of embodiments of the invention and concepts supra biometric data relating to a user is acquired upon an electronic device, e.g. their PED. In various embodiments of the present invention these may provide an adaptable user interface, which may transmit current biometric data of the user to a PED, such as to another device or system and may receive an electronic storage file or other indication of the current biometric information of the user from the PED. The file or message may contain code that enables a specific user interface capability for the PED, so that it displays a version of the user interface based on the contents of the electronic storage file which relate to the user's biometric data based upon factors including, but not limited to, the biometric data, the context of the user, the value of specific elements of the biometric data. The storage file may be transmitted from a remote location and may without limitation be in a format such as an XML document, a script, an HTML document, a program, a database, a table, a message, a folder, an application, an animation and/or a text file. The storage file may contain user interface information, such as specific menus that may be for a specific biometric condition and/or specific allocations that may be for a specific set or subset of biometric data. The storage file may be updatable, wherein the user may manually update the storage file with information/configurations etc. or wherein the storage file may be automatically updated with information/configurations etc. The update may occur when a user's context changes, for example, or their biometric data logging terminates or is halted temporarily such as a disassociation of the user's biometric devices, wearables etc. from a PED acquiring/consolidating/analyzing the biometric data prior to its transmittal to the remote storage facility. The user may modify the interface or in other instances the interface may be locked by another user, the user's current biometric data etc. and may be released upon a change in the user's current biometric data such that it meets predetermined criteria.

For example, a user's PED may block all activity and lock functions when the user's blood sugar level exceeds a predetermined threshold and will only unlock once the user has performed an action or actions that bring the blood sugar level down to below the predetermined threshold. During this period of lock the display interface may present, for example, a graphical representation of the user's blood sugar over a period of time together with the predetermined threshold. Emergency call functionality may, for example, be left enabled and if the user does not address the excess blood sugar within a predetermined period of time then an alarm is triggered and communicated to an external third party. Optionally, at the same time the PED may generate a different screen seeking help from anyone viewing it, may generate an audible alarm. Other biometric conditions may be monitored using discrete biometric values or combinations of biometric values.

According to embodiments of the invention an adaptable user interface may provide for receiving biometric-based information associated with the PED and outputting a version of such information through the PED. The information may be received in response to a transmission of the biometric data of the PED triggered in dependence upon a location, a, a biometric event, a biometric fence, or a context. The output version of such information may without limitation be visual, audio, a facsimile, an email, voice, a light, a change in the intensity of a light, a change in the color of a light, via SMS, via an instant message, via a text message, and/or an application that may only be available at certain locations. In some embodiments, at least one menu item may be changed in response to the information. The information may be defined in relation to the biometric information. The information may be a biocentric list. The information may be specific to a user, to a group of users, and may without limitation alter the look and feel of the PED, alter the functionality of the PED, be in an XML format, be in a database format, and/or be in a text file format. An alert, which may relate to an item on a list, may be triggered in response to the information. The present invention may provide for biometric tracking, wherein biometric data associated with a PED may be transmitted, stored in a file, stored with other information in the PED, and reported along with an indication of the actions, context, location, etc. of the PED. The information itself may be displayed on a map and may comprise an indication of absolute biometric data and changes in biometric data. Said biometric data may be a discrete item of biometric data or a combination of biometric data analysed/processed/raw etc.

For example, a jogger may be presented with a biometric fence in relation to heart rate and run rate where the combination is within a predetermined band representing beneficial increases against their normal levels. Also depicted in combination or discretely may be a second biometric fence relating to where the user's biometrics were within a range consider unsafe. Accordingly, the jogger may adjust their training regimen to either change their running in those areas or adjust the run to avoid them. Optionally, the jogger may be presented with options by the software application(s) that are automatically generated to provide route options between a start/end locations that provide the beneficial increase in metabolism.

The present invention may provide methods and systems for effecting change on a PED in response to biometric information. The method may involve receiving biometric information on the PED and effecting a change on the PED based on the biometric information. The change may involve activating the portable electronic device, powering off portable electronic device, placing the portable electronic device in standby mode, starting an application, stopping an application or the output of information. The output may involve audio, video, a picture related a biometric, fax, email, instant message, text message, SMS, internet protocol, voice, voicemail, vibration, stimulation at least one of the five senses or an alert. The alert may involve fax, email, instant message, text message, SMS, internet protocol, voice, voicemail, vibration or stimulation of at least one of the five senses.

The change may involve a reminder regarding an item on a list and the list may be a biocentric list. The change may involve a change to at least one item on a menu. The change may affect the availability of an application. The change may also involve enabling free calling when within a certain biometric fence, such as calm and at rest rather than agitated and only allowing emergency dialing when the user is an agitated state in motion.

The biometric information may relate to the accuracy of the biometric information. The information may refresh continuously, in accordance with set preferences or in response to a request. The frequency of the requests may be varied in response to a biometric fence, biometric data, specified preferences, proximity to biometric fence, or changes in a biometric fence. The present invention may provide for methods and systems of triggering the output of biometric-based information involving receiving information via a PED and outputting biometric-based information based on the received information.

The present invention may provide methods and systems of varying transmissions for a PED involving varying information transmissions to a PED and varying information transmissions from a PED. The length or frequency of the transmissions may be varied. The variation may be in response to biometric data, a biometric fence, preferences, a biometric fence with respect to a geofence or changes in a geofence/biometric fence. The present invention may provide methods and systems of increasing the quality of biometric based information for a user provided to their PED involving obtaining multiple data points for a given item of information or a biometric. The multiple data points may be analyzed and outliers dropped. The analysis may be performed using an algorithm.

The present invention may provide methods and systems of defining a biometric fence on a PED involving inputting the biometric fence using the PED. The mean, deviation, limits, etc. of a biometric fence may be entered on the PED. The biometric fence may be defined using a cursor on the display of the PED relative to a range of the biometric. The biometric fence may be defined using a touch screen on the PED. The biometric fence may be defined by the biometric data stored. The biometric fence may be defined by selecting locations and capturing the biometric data at these locations to define the biometric fence. The biometric fence may be established by one or more third parties, e.g. medical professionals, regulatory authorities, etc.

The present invention may provide methods and systems of sending biometric-based alerts involving determining the biometric of a PED and sending an alert based on the biometric of the PED. The alert may be in response to the biometric of a PED with respect to a biometric fence. The alert may be via audio, video, fax, email, instant message, text message, SMS, internet protocol, voice, voicemail, vibration or may stimulate at least one of the five senses. The alert may be communicated via one of the following means of communication: SMS, fax, email, instant message, internet protocol, voice, voicemail, GPRS, CDMA, WAP protocol, internet or text.

The present invention may provide methods and systems of analyzing information related to at least one PED involving transmitting information from the at least one PED and analyzing such information using an analysis engine. The information from one or more portable electronic facilities may be stored or aggregated. The analysis engine may provide the ability to view biometric history or analyze biometric history. The analysis engine may also request additional information or send alerts. The analysis engine may perform analytics on biometric information such as demographic analysis, predictive analysis and descriptive analysis. The information provided by the analysis engine may include purchasing information, personal preferences, demographics or consumer purchasing data relating to individual consumers or classes of consumers.

Access to the analysis engine, the system and information may be granted at different access levels. A user may be granted partial or restricted access via a guest login. It may be that whether a user is permitted to know the biometric of another user is determined based on the access levels of the users. Several possible graphical user interfaces may be presented on a PED. The interface may display a map or a menu or provide an overview of the biometrics of all the users in a defined group or of the biometric history of a particular user. The view may involve the use of tiled maps. The graphical user interface may present a stop report. A biometric fence may be created using a graphical user interface and an icon may be assigned to a biometric fence. A graphical user interface may also display an address book or be used to define alerts. Graphical user interfaces may also be used to present of points of interest on a PED. A graphical user interface that may allow a user to vary the frequency with which a portable electronic device obtains biometric information.

Advances in solid state based nanotechnologies are providing the ability to map the DNA of an individual. For example, nanopores and microfluidics provide the ability to integrated fluidic chemical processes and detection stages of a DNA sequencer into a single solid stat circuit. Accordingly, a DNA sample may be processed to initially attain distinction between the four DNA nucleobases through use of a biochemical procedure for DNA expansion. Accordingly, each nucleobase in each DNA strand is converted into one of four predefined unique 16-mers in a process that preserves the nucleobase sequence. The resulting converted strands are then hybridized to a library of four molecular beacons, each carrying a unique fluorophore tag, that are complements to the 16-mers used for conversion. Solid-state nanopores are then used to sequentially remove these beacons, one after the other, leading to a series of photon bursts in four colors that can be optically detected. Accordingly, the solid state circuit can be used to identify and differentiate genes with a high level of sequence similarity at the single-molecule level, but with different pathology or response to treatment. Similarly, such a solid state circuit can be used to identify and differentiate genes for the individual.

Accordingly, widespread deployment of such solid state circuits with user's combining information anonymously or openly would allow crowd sourcing of DNA data together with the associated user's biometric data and medical history. Such data may be used to establish/verify associations between particular DNA markers and physical/physiological/neurological factors/effects. Similarly, the DNA data may be exploited in matching user's in a variety of manners. For example, users identified with particular genetic markers may be associated with other individuals, third parties, medical facilities, GPs, enterprises etc. based upon the genetic marker identified in a manner similar to that described supra in respect of SOCNETs/SOMEs etc. and biometric data. Within other embodiments of the invention the user may be asked to provide genetic data relating to their family alone or in combination with genetic sequencing.

Alternatively, users may be matched/characterised within one or more applications including, but not limited to, SOCNETs and SOMEs based upon the genetic markers within their DNA and/or genetic data discretely or in conjunction other biometric data. Accordingly, a user may access a matchmaking service seeking a lifetime partner with their profile stating a desire to have children. However, in some instances the service may filter matching results based upon genetic characteristics or identify genetic issues relating to another user. For example, if the user has Crohn's disease and they have a child with a partner without the disease then there is an approximately 8 percent lifetime risk for the child to develop the condition and an approximately 10 percent chance their child will develop some form of inflammatory bowel disease. However, if both parents have inflammatory bowel disease, the risk for their children to develop Crohn's disease rises significantly to approximately 35 percent. Accordingly, the user may decide that this risk level is too high and accordingly their search results will be filtered based upon removing individuals with inflammatory bowel disease. Similarly, approximately one in 30 Americans, more than 10 million people, are symptom-less carriers of the defective cystic fibrosis (CF) gene and can pass on the defective gene to their children. To develop CF, a child must inherit a defective gene from both parents wherein if both parents are carriers, there is a 25 percent chance that each child they conceive will have CF, and a 50 percent chance that the child will be a carrier. Alternatively, the search results within such a service may indicate markers associated with those individuals where such an issue arises rather than filtering these out.

Detecting Illegal—Notifiable Activities through Biometric Data: Within other embodiments of the invention the acquisition of biometric data in respect of a user may be acquired directly by a device in association with an event or it may be acquired through accessing cloud based data, ad hoc network linking etc. For example, a camera in association with an automatic teller machine (ATM) may establish the presence of multiple individuals within the field of view rather than the normal discrete user and note that the heart rate and breathing of the user whose financial card has been inserted is erratic, racing, abnormally elevated etc. Accordingly, whilst dispensing the requested funds in the interest of the safety of the user it may alert the authorities to suspicious activity.

Similarly, a camera monitoring a traffic intersection may determine that an accident has occurred but based upon the analysis of the biometrics of the driver(s), passenger(s), etc. determine whether any injuries have occurred such that the reporting may be solely to the police where no injuries are expected through the biometric data analysis or alternatively if there are injuries and/or medical issues determined then paramedics may be notified in addition to the police.

Accordingly, based upon determined events of potentially illegal, illegal, or notifiable nature biometric data and biometric data analysis may adjust the notifications, alerts, alarms, parties notified etc.

Avatar Marketplace(s): Embodiments of the invention allow avatars and the avatar SSSA to provide a marketplace allowing users to purchase hardware and software for biometrics. In the following paragraphs sections relating to software, hardware, and packages according to embodiments of the invention with respect to avatar marketplace(s) are presented. This list is non-exhaustive.

Software Marketplace: Features relating to an avatar can be purchased/enhanced from an avatar software marketplace. Third party developers can create and sell software features that work within the avatar platform to build upon and enhance/expand the SSSA through discrete and/or aggregated raw data from discrete/multiple sensor devices and/or wearables to provide advancements/enhancements to the avatar as well as notifications, predictions, insights, gear and other software features etc. Any part of the avatar can be advanced and customized with software purchased from the marketplace including, but not limited to, expanding “skinning” options, context definition and display, biometric data acquisition/processing/display, and animation.

Hardware Marketplace: Users will also be able to buy hardware for biometric logging from an avatar marketplace according to embodiments of the invention. The marketplace may list all wearables, their attributes, and the software support currently available for those wearables for their avatar. They will also be able to see what wearables/sensors others employ as well as engaging in discussion forums, engage other avatars for feedback etc.

Packages: Users may purchase pre-built avatar profiles that combine a set of hardware, e.g. wearables, software, and other elements such as contexts, skins, etc. to give new users to the SSSA platform a turn-key solution. Wearable manufacturers, equipment manufacturers, etc. may leverage such packages to build brand/product support as well as supporting brand and/or product communities.

Avatar Incubation—Birth: An initial avatar may be provided within the SSSA when the user register, logs in, purchases etc. according to the manner in which they initially access the avatar SSSA. This initial avatar may be a unisex three-dimensional (3D) model that can become male or female. The user upon initializing their avatar is prompted to feed the avatar data that will allow it to take its initial form and to evolve such that there is in essence an incubation period where the avatar is growing as the initial data is entered/generated by the user or acquired from linked SOCNETs/SOMEs etc. During this period the avatar may be shown as an embryo through various growth stages in much the same way as a human grows.

Avatar Timeline: Each avatar has a timeline as the user acquires the avatar and the avatar evolves. As the user scrolls back and forth along the timeline the displayed avatar changes relative to the user's biometrics and physiology at that time. A user may see multiple timelines simultaneously and compare visual biometrics from multiple sources at the same time to give a much wider and more accurate view of their biometrics. The user may view their physical appearance, nutritional information, gear, etc. as well as other views at the same time allowing them to see and compare biometrics etc. that affect each other on a timeline.

Avatar Interface: Avatars may within embodiments of the invention have inbuilt intelligence allowing them to interface to other electronic devices apart from the device upon which the SSSA is active. The avatar may then perform actions as authorised by the user. Additional actions, interfaces, etc. may be acquired through a marketplace such as described supra.

Intelligence Building: Whilst the initial avatar will have intelligence built into the system this may be expanded/extended through integration of third party applications, modules, etc. Such intelligence and enhancements may include, for example, emergency notifications. For example, if a user's heart rate reaches Y and their perspiration X for Z amount of time then an emergency notification is made. Similarly, if during the hours that a schoolgirl walks home from school and biometric activity indicates a condition such as stress or panic then the avatar SSSA triggers an emergency notification through the smartphone either to the police or alternatively to emergency family contacts in her profile whilst microphone, GPS and other features of her electronic device is disabled are enabled but without the notifications usually associated with these features such that should an attacker look they will think the features turned off.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method comprising:
aggregating biometric data relating to a user with user data relating to the user;
generating in dependence upon the aggregated data an avatar for presentation upon an electronic device.

2. The method according to claim 1, further comprising:
at least one of:
a first series of steps comprising:
generating a baseline avatar in dependence upon biometric data relating to a user and user data relating to user;
dynamically adjusting characteristics of the baseline avatar in dependence upon changes in the user's biometrics; and
skinning the baseline avatar in dependence upon a context of the user;
a second series of steps comprising:
classifying the biometric data and user data according to at least one of skills, health, intelligence, emotions, and relationships; and
dynamically adjusting the avatar in dependence upon the classification of the data;
a third series of steps comprising:
establishing an application environment within which the avatar will be displayed; and
skinning the avatar in dependence upon at least the application environment and a context of the user; and
a fourth series of steps comprising
determining whether the biometric data relating to the user meets a predetermined criteria established in relation to a social network that the user wishes to at least one of join and collaborate with.

3. The method according to claim 2, wherein at least one of:
the biometric data is acquired in real-time;
the avatar reacts to changes in the user data;
the avatar adjusts to reflect at least one of a specific type of biometric data and a predetermined subset of the biometric data; and
the baseline avatar is generated in dependence upon at least an image of the user.

4. (canceled)

5. (canceled)

6. (canceled)

7. The method according to claim 1, further comprising:
at least one of:
a fifth series of steps comprising:
determining whether a user may at least one of connect, access, control, and communicate at least one of information, a feature, and an ability to at least one of an electronic device and a network from another electronic device associated with the user in dependence upon whether a predetermined subset of the biometric data relating to the user meets a predetermined condition; and
a sixth series of steps comprising:
providing a reward within an online environment based upon the user achieving a predetermined biometric threshold and the gained reward is evident through a predetermined adjustment in the avatar associated with the user, wherein
the reward is determined in dependence upon at least one of other biometric data relating to the user, the predetermined threshold, a skill associated with the user, and a characteristic associated with the user; and
the predetermined biometric threshold must be met continuously for the reward to be maintained.

8. (canceled)

9. (canceled)

10. The method according to claim 1, further comprising:
acquiring the biometric data relating to the user over a period of time;
acquiring over the same period of time physical appearance data relating to the user; and
generating the avatar is established in dependence upon the biometric data and physical appearance data of the user at a predetermined point in time.

11. The method according to claim 10, wherein at least one of:
the user may move a cursor to adjust the predetermined point in time and the avatar automatically adjusts to reflect the biometric data and physical appearance data of the user at the new predetermined point in time;
the user may move a cursor to adjust the predetermined point in time and the avatar automatically adjusts to reflect the biometric data and physical appearance data of the user at the new predetermined point in time and to display characteristics of the user at the new predetermined point in time associated with at least one of skills, employment, family, and activities;
the avatar is displayed in association with a timeline showing at least one of a single biometric or a plurality of biometrics; and
the avatar is displayed as part of an avatar filmstrip such that the user can view the avatar filmstrip in dependence upon an action by the user;
the avatar and biometric data may be viewed over a timeline which is dynamically set by the user and portrayed in accordance with a template based upon the biometric data being displayed;
the avatar and biometric data may be viewed over a timeline in association with at least one of a benchmark avatar and benchmark biometric data where the at least one of is generated in dependence of a population group based upon at least a demographic factor of the user;
the avatar and biometric data may be presented to the user indicative of a predetermined point in the future based upon at least one of an adjustment and no adjustment of an aspect of the user's lifestyle;
the avatar and biometric data may be presented in a plurality of alternates, each alternate indicative of a projection of the user's avatar and biometric data to a predetermined point in the future based upon at least a scenario relating to the user's lifestyle.

12. (canceled)

13. The method according to claim 1, wherein
the avatar is displayed in dependence upon a selected biometric and a value of the selected biometric wherein the avatar displays at least one of a skeletal, circulatory, cardiovascular, and nervous system.

14. A method comprising:
aggregating biometric data relating to a user;
allowing the user to select a predetermined subset of the aggregated biometric data to be displayed as part of a profile within a social network associated with the user; and
allowing the user to determined what portion of their displayed profile within the social network to other users is based upon the predetermined subset of the aggregated biometric data.

15. A method according to claim 14, wherein at least one of:
the data relating to the plurality of biometrics are presented as an avatar established in dependence upon the plurality of biometrics and predetermined data relating to the user;
the user can set preferences relative to but not limited to at least one of each feature of the avatar and its biometrics;
the user is notified when another user at least one of views and follows their avatar;
the user can clear all the information relating to their avatar within the social network; and
the user is notified if their profile is at least one of copied and shared.

16. The method according to claim 14, further comprising
allowing another user to at least one of view and follow the user on a social network, wherein the user is established in dependence upon at least one of a search and filtering process performed in dependence upon the aggregated biometric data relating to the user meeting a predetermined criteria.

17. The method according to claim 16 wherein at least one:
a notification is sent to the follower of the at least one of when certain biometric thresholds relating to the at least one of are met;
the biometric data are associated with avatars for each of the at least one of;
each of the at least one of is anonymous; and
each of the at least one of has chosen to display an avatar in dependence upon at least a baseline avatar generated in dependence of their physical self which is modified in dependence of their biometric data.

18. The method according to claim 1, further comprising:
generating the avatar further comprises presenting them with an avatar whose characteristics are derived in dependence upon the aggregated biometric data and a context of the user; wherein
the context is established in dependence up at least one of a calendar, a location, a social network, and a mood wherein the at least one of relates to the user.

19. The method according to claim 1, wherein at least one of:
the avatar automatically triggers an electronic communication when one of more thresholds relating to the biometric data are exceeded;
the information relates to a challenge relating to the user provided by at least one of another user, a group of users, and an avatar relating to another user;
the information relates to a challenge relating to the user, the challenge requiring the user to adjust a biometric until it meets a threshold;
the information relates to a challenge relating to the user, the challenge requiring the user to adjust a plurality of biometrics until they meet a plurality of thresholds; and
the information relates to whether a challenge previously communicated to the user has been lost or won.

20. (canceled)

21. (canceled)

22. (canceled)

23. The method according to claim 1, further comprising;
providing a recommendation to the user in respect of at least one of a software application and an item of sensory hardware in dependence upon at least the aggregated biometric data relating to the user.

24. (canceled)

25. (canceled)

26. (canceled)

27. (canceled)

28. (canceled)

29. A method of presenting a profile of a user within a social network to another user comprising:
retrieving data relating to an avatar associated with the user;
retrieving data relating to the current context of the user;
retrieving data relating an appearance of the avatar, the appearance of the avatar determined in dependence upon the social network and the current context of the user;
generating a representation of the avatar based upon the data relating to the appearance as part of a social network profile associated with the user;
displaying the social network profile to another user.

30. The method according to claim 29, further comprising;
at least one of:
generating a further part of the social network profile associated with the user by filtering biometric data for the user in determination upon at least one of the social network, the current context of the user, and the identity of the another user; and
modifying the representation of the avatar in dependence upon filtered biometric data, the filtered biometric data relating to the user and filtered in dependence upon at least one of the social network, the current context of the user, and the identity of the another user.

31. (canceled)

32. (canceled)

33. (canceled)

34. The method according to claim 1, further comprising:
associating a biometric fence with respect to the user;
processing the aggregated biometric data in dependence upon a predetermined threshold of a plurality of thresholds to determine whether to apply to the biometric fence to the user.

35. The method according to claim 34, wherein
the predetermined threshold is established by at least one of:
receiving input from the user;
receiving indications of a plurality of locations and filtering the biometric data relating to the user in dependence upon the plurality of locations;
a regulatory authority; and
a medical authority.

36. The method according to claim 34, wherein
at least one of:
an action is triggered in dependence upon the user's biometric data crossing the biometric fence; and
the biometric fence is established in conjunction with a geofence.

37. (canceled)

38. (canceled)

39. A method comprising:
automatically generating a profile of a user upon an electronic device by observing activities that the user partakes in, observing locations that the user visits, and associating the aggregated biometric data of the user with each activity and location; and
at least one of:
determining an activity of a user based upon the profile of the user and the user's current biometric data;
determining an action to be made in respect of a machine based upon the activity of the user; and
determining whether to grant access to at least one of a computer system, a software application, a machine and a mode of transport in dependence upon validating the current aggregated biometric data against a stored biometric profile of the user.

40. (canceled)
